(19) United States
(12) Patent Application Publication
(10) Pub. No.: US 2026/0057214 A1
(43) Pub. Date: Feb. 26, 2026

(54) INCORPORATING COMPLEX PRODUCT REQUIREMENTS IN SEARCH RANKING SYSTEM

(71) Applicant: Microsoft Technology Licensing, LLC, Redmond, WA (US)

(72) Inventors: Rupesh Gupta, Newark, CA (US); Ali Hooshmand, Menlo Park, CA (US); Sarang Metkar, Redmond, WA (US); Chujie Zheng, Newark, CA (US); Xin Yang, Sunnyvale, CA (US)

(73) Assignee: Microsoft Technology Licensing, LLC, Redmond, WA (US)

(21) Appl. No.: 18/814,871

(22) Filed: Aug. 26, 2024

(51) Int. Cl. G06N 3/0455; G06N 3/0985

(52) U.S. Cl. CPC G06N 3/0455; G06N 3/0985

(57) ABSTRACT

Artificial intelligence (AI) techniques for connection networking are described. A method comprises generating a first training prompt based on a set of guidelines for a network service of a connection network system, the guidelines defining an objective for the network service, sending the first training prompt and a first set of training datapoints from a first training dataset to a first generative AI model, a training datapoint from the first set of training datapoints comprising a content item, receiving a second set of training datapoints for a second training dataset from the first generative AI model, wherein a training datapoint of the second training dataset comprises a first label for the content item generated by the first generative AI model based on the objective, and training a second generative AI model using the second set of training datapoints based on the objective. Other embodiments are described and claimed.

### BACKGROUND

A social networking system is an online platform where connections can create profiles, connect with friends, family, and colleagues, and share various types of content such as photos, videos, and status updates. These platforms often offer features like messaging, groups, events, and news feed to keep connections engaged and connected. connection network systems facilitate communication, networking, and content sharing among connections, creating a digital community where people can interact and engage with others in their social circle or with like-minded individuals. Similarly, a connection network system allows individuals to connect with colleagues, potential employers, and other professionals in their industry. It is geared towards professional networking, job searching, and recruiting. Professionals can create a profile showcasing their work experience, skills, and education, as well as connect with others in their field. Connection network systems also provide a platform for sharing content, participating in discussions, and accessing industry news and insights.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a connection network system in accordance with one embodiment.

FIG. 2 illustrates an apparatus in accordance with one embodiment.

FIG. 3 illustrates a logic diagram in accordance with one embodiment.

FIG. 4 illustrates a logic diagram in accordance with one embodiment.

FIG. 5 illustrates a logic diagram in accordance with one embodiment.

FIG. 6 illustrates a logic diagram in accordance with one embodiment.

FIG. 7 illustrates a logic diagram in accordance with one embodiment.

FIG. 8 illustrates a logic diagram in accordance with one embodiment.

FIG. 9 illustrates a logic diagram in accordance with one embodiment.

FIG. 10A illustrates a prompt template in accordance with one embodiment.

FIG. 10B illustrates a prompt template in accordance with one embodiment.

FIG. 11 illustrates a logic flow in accordance with one embodiment.

FIG. 12 illustrates a logic flow in accordance with one embodiment.

FIG. 13 illustrates a system in accordance with one embodiment.

FIG. 14 illustrates an artificial neural network (ANN) in accordance with one embodiment.

FIG. 15 illustrates a computer-readable storage medium in accordance with one embodiment.

FIG. 16 illustrates a computing architecture in accordance with one embodiment.

FIG. 17 illustrates a communications architecture in accordance with one embodiment.

### DETAILED DESCRIPTION

Embodiments are generally directed to a connection network system. Some embodiments are particularly directed to artificial intelligence (AI) and machine learning (ML) techniques to support applications and/or services provided by a connection network system. Although exemplary embodiments are described in connection with a particular AI system or an ML model, the principles described herein can also be applied to other types of AI systems and ML models as well. Embodiments are not limited in this context.

### Overview

A connection network system may provide access to a large amount of content aimed at professional networking and career development. For example, a connection network system may list employment opportunities posted by employers across different industries, professional profiles with detailed information about users of the connection network system (e.g., work experience, skills, and endorsements), articles or posts created by users and industry leaders covering various topics (e.g., business, technology, and career advice), online courses and tutorials on a wide range of professional skills and subjects, company profiles offering insights about a company (e.g., company culture, job openings, and industry news), connections and networking tools to connect with and recommend other professionals, forums and discussion groups where users can share ideas and discuss industry trends, and other types of content designed to facilitate professional growth and industry engagement.

A connection network system typically offers a search application to search for content items provided by the connection network system. A user enters a search query in a graphical user interface (GUI) element of the search application, typically in a written natural language suitable for natural language processing (NLP). The search application executes a search algorithm to search for content items relevant to the search query. The search application also executes a ranking algorithm to rank the content items, and it returns a search result comprising a list or ranked content items. A user views the search results and selects a content item for closer inspection.

A fundamental purpose of a search application is to find content items relevant to a user as expressed by a given search query. To measure relevance, different types of metrics were developed, such as precision, recall, and F1 score. Precision in search applications refers to the measure of accuracy in retrieving relevant documents or information from a dataset. It is defined as the ratio of the number of relevant documents retrieved to the total number of documents retrieved. High precision indicates that retrieved results are highly relevant to the search query, while low precision indicates that many irrelevant documents are retrieved. Recall in search applications measures the ability of the system to retrieve all relevant documents from a dataset. It is defined as the ratio of the number of relevant documents retrieved to the total number of relevant documents available in the dataset. High recall indicates that the system retrieves most or all relevant documents, while low recall indicates that many relevant documents are not retrieved. An F1 score is a metric that combines precision and recall providing a single measure of model performance. It is the harmonic mean of precision and recall, giving a balanced measure that considers both false positives and false negatives. An F1 score ranges from 0 to 1, where 1 indicates perfect precision and recall, and 0 indicates the worst performance. It is particularly useful when the distribution of classes is uneven.

These metrics, while useful, depend on a very broad meaning of the term relevance. While a content item may be relevant to a search query, it does not necessarily mean the content item is of actual interest to a user. To better measure relevance, search applications may define other search criteria specific to a user, a domain, or a system. For example, one type of search criterion is engagement. Engagement is measured using historical data such as a length of time a user previously engaged with a content item. The assumption is that a longer period of time increases relevance. However, a user A spending time reading a content item does not mean a user B is also interested in that same content item. Another type of search criterion is quality. Quality is measured by comparing a topic of a search query with a topic of a content item. Comparing topics, however, is a generic form of measure. For example, assume a pair of matching topics is “computer.” A user searching to buy a new computer would not find content items about programming a computer very relevant. Consequently, these other types of search criteria still fall short of finding content items of interest to a user.

To complicate the problem of measuring relevance is one of speed and scalability. Global online systems may store millions of content items around the world. Given the increasing number of available content items, it becomes increasingly difficult to search through a universe of content items for items relevant to a given search query. Traditional programming code is simply too slow in returning relevant content items, even when a search service indexes the content items to accelerate search and retrieval. This is particularly true when online systems are executing multiple searches in parallel. To assist in this endeavor, a search application may use an ML model to assist in a search. For example, a ML algorithm may train an ML model to search for content items meeting certain search criteria. A compute system can execute a trained ML model much faster than conventional code using less technical resources.

Training an ML model for a search application is a complex task and it involves many technical challenges. For example, training a generative pretrained transformer (GPT) requires billions of tokens. Ensuring the availability of sufficient high-quality, labeled data is critical, as inadequate or noisy data can degrade performance. The traditional approach to solving this problem is to have humans manually label a large number of training datapoints. This approach is time consuming and requires a significant amount of cost and effort. It also creates imbalanced data skewed by relevance judgments. Another problem is finding features that correlate well with the manually annotated data. A model designer may experiment with hundreds of features to find a combination that extracts relevant characteristics from textual data to enhance understanding and retrieval accuracy. This is a slow and tedious process involving a trial-by-error approach. Further, scalability and latency are crucial factors, particularly when handling large datasets and high query volumes efficiently while maintaining rapid response times. This is especially important for online systems handling millions of simultaneous search requests for content items stored in systems around the world. In addition, some ML models such as neural networks use billions of parameters and thousands of neural network layers, with each layer comprising a large number of nodes (e.g., neurons). Such heavyweight models consume a significant amount of technical resources for training and inferencing operations, such as compute, communication, memory, power, thermal management, and so forth. Conversely, smaller lightweight models may result in poor performance, such as delivering search results with low precision, recall, or F1 scores. In addition, some ML models are specifically trained or fine-tuned to meet certain objectives, such as searching for specific content (e.g., news items) in certain domains (e.g., a news website). Retraining such ML models for different objectives may require a substantial number of new training datapoints, time, and technical resources, such as searching for different content (e.g., movies) of a certain genre (e.g., adventure). These and other challenges demand innovative and carefully designed solutions to create effective ML models suitable for search applications.

Embodiments solve these and other technical challenges. Embodiments are generally directed to AI and ML techniques to support various network services for an online connection network system. Some embodiments are particularly directed to a novel training technique to train an ML model to support network services for an online connection network system. Examples of network services include search services, ranking services, recommendation services, advertising services, and so forth. Once trained, the trained ML model is deployed to perform inferencing operations in support of a network service.

In one embodiment, for example, a training device uses knowledge distillation to train a student model using a teacher model. The teacher model generates training datapoints for a training dataset using a set of guidelines. A guideline defines an objective for the network service, such as engagement, quality, precision, recall, F1 score, and other types of objectives. The training device then trains the student model using training datapoints from the training dataset. When an objective for the network service changes, the teacher model generates a new set of training datapoints for a new training dataset. The training device then re-trains the student model using the new training dataset.

A teacher model trains a student model using a technique referred to as knowledge distillation. A teacher model is a large, complex model that has been trained with high accuracy on a given task. It can be a neural network with many parameters, such as a deep convolutional neural network (CNN) or a transformer. The teacher model serves as a high-performance reference. A student model is a smaller, simpler model that is trained to imitate the performance of the teacher model. The student model aims to achieve comparable accuracy with fewer computational resources. The training involves minimizing the difference between the outputs of the teacher and student models, typically using techniques like soft or hard target outputs and techniques to retain performance while reducing complexity. Together, they are used to create ML models that are efficient for deployment in resource-constrained environments such as mobile devices or edge computing, or in dynamic environments such as online connection network systems where the ML models need re-training on a periodic basis.

In particular embodiments, a teacher model is a generative AI model. One example of a generative AI model is a language model utilizing a transformer architecture, such as a large language model (LLM). The generative AI model uses a set of guidelines to generate training datapoints for a training dataset. A training device trains a student model using the training dataset. Similar to the teacher model, the student model may comprise a language model utilizing a transformer architecture, such as an LLM. However, the LLM of the student model is smaller than the LLM of the teacher model. For example, the LLM of the student model may utilize fewer parameters and neural network layers relative to the LLM of the teacher model, and is therefore much more efficient. For example, the student model may have a reasonable size of 435 million parameters relative to billions of parameters needed for the teacher model. The smaller size of the student model reduces latency for inferencing operations of the student model, which makes it suitable for large, global online systems, such as a connection network system. In addition, when the student model is combined with other data processing techniques (e.g., batch inference, limited number of output tokens for a content item, etc.), it further reduces latency for inferencing operations of a system using the smaller student model.

The training device deploys the trained student model to an inferencing device. In one embodiment, for example, the trained student model is designed to support an advanced search application for a connection network system. The advanced search application is designed to search for content items accessible by the connection network system. The connection network system stores the content items or provides access to content items stored by third party systems via a set of application program interfaces (APIs). The advanced search application searches for content items based on various search objectives, such as engagement, quality, accuracy, speed, relevance, personalization, and so forth. In one embodiment, for example, the advanced search application searches for content items based on an engagement metric and a quality metric. The engagement metric is a measurement or score representative of a level of engagement between a user and a content item. For example, the engagement metric is generated using activity data of one or more users. The quality metric is a measurement or score representative of a level of quality of a content item relative to a search query as defined by a set of guidelines. The advanced search application uses the engagement metric and the quality metric to search for a set of candidate content items provided by the connection network system in response to a search query, rank the set of candidate content items based on the engagement metric or quality metric, select a subset of the ranked candidate content items to form a set of ranked content items, and return a search result with the set of ranked content items.

In various embodiments, a guideline defines an objective for a network service. In one embodiment, for example, a guideline comprises a series of natural language processing (NLP) instructions in a chain of thought (CoT) format to define an objective in a manner suitable for a generative AI model. For example, assume a network service for a connection network system is a search service and an objective of the search service is to search for a certain level of quality of content items. A guideline may comprise a series of NLP instructions in a CoT format to determine a quality level of a content item for the search service, which is represented by a metric such as a quality metric. A first generative AI generates a set of training datapoints for a training dataset using the guideline. The training device trains a second generative AI using the training dataset. Once trained, the second generative AI is deployed to perform inferencing operations to generate a quality metric for a content item consistent with the guideline.

In one embodiment, for example, the quality metric is based on a set of graded relevance (GR) guidelines. The GR guidelines comprise a set of instructions or rules that define different levels of quality associated with a given content item relative to a given topic of a search query. The GR guidelines define a set of query categories for a search query. A query category represents a general topic of a search query. Non-limiting examples may include a search query for a company name, a job title, a job skill, knowledge seeking, news, and other topics. The GR guidelines also define a set of quality rules for each query category. A quality rule comprises a specific attribute, condition, criterion, property, characteristic, or standard associated with a content item that is needed to meet a given level of quality within each query category. The level of quality is defined by a quality scale, such as a set of numerical values representing different levels of quality. For example, a quality scale may have three defined quality levels of low, medium, and high represented by numerical values 0, 1, and 2, respectively (e.g., 0=low quality, 1=medium quality, 2=high quality). Embodiments are not limited to this example.

A first generative AI model generates a training dataset using the GR guidelines. In one embodiment, for example, the first generative AI model is a transformer-based neural network, such as a generative pretrained transformer (GPT) model. The first generative AI model receives as input a prompt generated from a prompt template associated with the GR guidelines. The first generative AI also receives as input a search query, a content item, one or more properties associated with a content items (e.g., age), and other types of inputs. The first generative AI generates a query category for the search query and a quality metric for the content item relative to the query category. The quality metric is a value that represents a level of quality of a content item relative to a search query based on a defined quality scale. This information is added as a training datapoint for the training dataset. This process is repeated until the first generative AI model generates a sufficient number of training datapoints, as defined by a hyperparameter, to train a second generative AI model for inferencing operations to determine whether a content item is relevant to a search query.

A ML algorithm trains a second generative AI model using the training dataset generated by the first generative AI model based on the GR guidelines. In one embodiment, for example, the second generative AI model is a transformer-based model, such as a bidirectional encoder representations from transformers (BERT) or a variant of a BERT such as decoding-enhanced BERT with disentangled attention (DeBERTa). The trained second generative AI model is deployed as an inferencing model to perform inferencing operations for a connection network system. For example, the inferencing model receives as input a search query and a content item, and it generates a quality metric for the content item relative to the search query based on the GR guidelines. A search application uses the quality metric to identify content items suitable for addition to a search result. The search application and/or a ranking model uses a ranking algorithm to rank the identified content items within the search results. In this manner, the connections network system may use the quality metric to improve and enhance other services offered by the connections network system, such as providing recommendations for advertisements, job postings, connection suggestions, and other types of services.

In one embodiment, for example, a training device generates a first training prompt based on a first set of guidelines for a network service of a connection network system. The first set of guidelines define an objective for the network service. The training device sends the first training prompt and a first set of training datapoints from a first training dataset to a first generative AI model. In one embodiment, for example, a training datapoint from the first set of training datapoints comprises a content item without a label for the content item. The training device receives a second set of training datapoints for a second training dataset from the first generative AI model, wherein a training datapoint of the second training dataset comprises a first label for the content item generated by the first generative AI model based on the objective. An ML algorithm of the training device trains a second generative AI model using the second set of training datapoints from the second training dataset using a loss function in order for the second generative AI model to generate a second label that corresponds to the first label for the content item based on the objective.

In one embodiment, for example, a search application receives a search query from a client device. The search application searches for a set of content items in response to the search query. The search application instructs the second generative AI model, deployed as an inferencing model, to generate a quality metric for each content item in the set of content items based on the search query. A ranking algorithm for the search application and/or a ranking model ranks the set of content items based on the quality metric. The search application causes a set of ranked content items to be presented on a GUI of the client device.

In some embodiments, the inferencing model may be implemented with other ML models in a layered architecture or ML framework comprising multiple layers L, where each layer L comprises a different ML model, where L represents any positive integer. For example, assume an ML framework comprises four layers (e.g., L=4) comprising layer 0 (L0), layer 1 (L1), layer 2 (L2), and layer 3 (L3). In one embodiment, for example, the inferencing model may be implemented as a final layer (e.g., L3) in a series of layers (e.g., L0, L1, and L2) for searching and ranking content items, where each previous layer (e.g., L0-L2) uses different ML models to successively narrow a number of content items before the trained ML model at L3 produces a final search result. The use of a layered architecture increases speed and reduces latency to produce a search result while maintaining a high level of performance.

The embodiments provide several technical solutions to various technical problems. For example, training an ML model to meet objectives of a network service requires a substantial amount of training data. Embodiments use knowledge distillation techniques to train a student model using a teacher model. The teacher model automatically generates the training data for the student model without human intervention. Further, the training data is balanced and unbiased since it is free of human relevance judgment. In another example, the generative AI automatically selects a set of features based on a set of guidelines, thereby avoiding the need for manual selection of features or feature engineering. In yet another example, the trained student model may be implemented in a layered architecture using different ML models to successively narrow a number of content items in a funnel before producing a final search result. This architecture allows for scalability and latency in online systems, particularly when handling large datasets and high query volumes efficiently while maintaining rapid response times. In addition, while the teacher model may use billions of parameters and thousands of neural network layers, the student model may use fewer technical resources for training and inferencing operations (e.g., compute, communication, memory, power, thermal management, etc.) while maintaining a level of performance similar to the teacher model. Further, a training device may quickly retrain the student model for different objectives by modifying the set of guidelines used by the teacher model. Embodiments provide innovative and carefully designed solutions to create effective ML models suitable for network services of a connection network system, such as search services, ranking services, recommendation services, and so forth.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### Detailed Embodiments

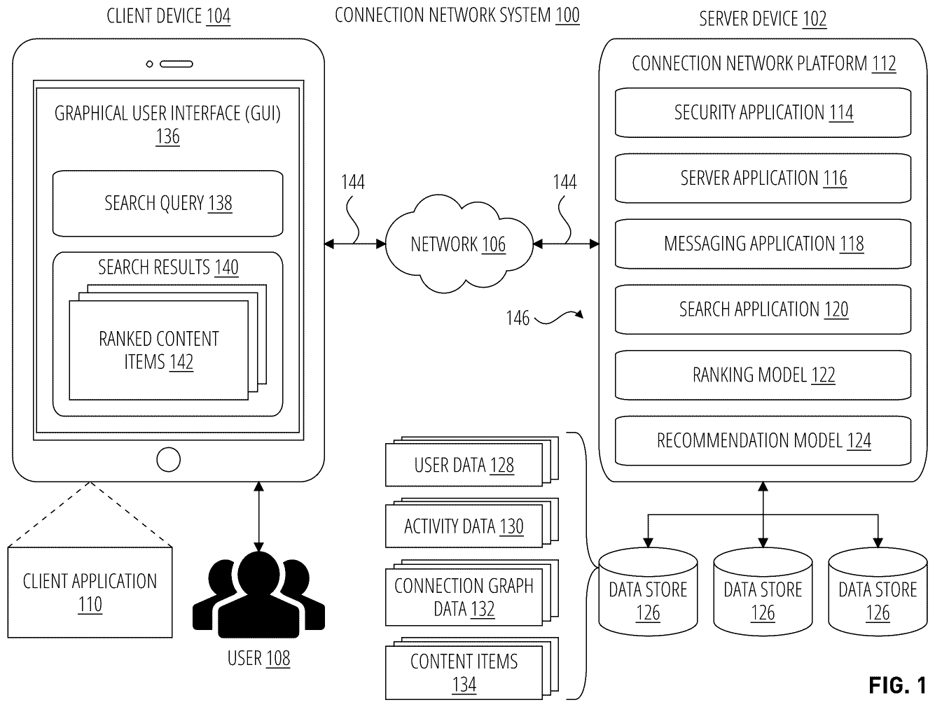

FIG. 1 illustrates a connection network system 100. The connection network system 100 is an example of an architecture or framework for an online computer and communications system designed to serve content items to an electronic device associated with a user. Embodiments are not limited to this example.

In general, the connection network system 100 may include a variety of servers, sub-systems, programs, modules, logs, and data stores. In particular embodiments, the connection network system 100 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The connection network system 100 may also include suitable components such as network interfaces, security mechanisms, load balancers, failover servers, management-and-network-operations consoles, privacy software, and other suitable components, or any suitable combination thereof.

As depicted in FIG. 1, the connection network system 100 comprises a server device 102 communicating with a client device 104 over a network 106. In operation, a user 108 interacts with a client application 110 of the client device 104 to access applications and services provided by a connection network platform 112 of the server device 102. The connection network platform 112 offers a number of network services 146 for the connection network system 100, such as network services provided by a security application 114, a server application 116, a messaging application 118, a search application 120, a ranking model 122, and/or a recommendation model 124. The server device 102 has access to one or more data stores 126. The data stores 126 store information for the connection network platform 112, such as user data 128, activity data 130, connection graph data 132, and content items 134.

The connection network system 100 comprises a server device 102. In particular embodiments, a server device 102 may be an electronic device including hardware, software, or embedded logic components or a combination of two or more such components and capable of carrying out the appropriate functionalities implemented or supported by a server device 102. The server device 102 may comprise a unitary server or a distributed server spanning multiple computers or multiple data centers. The server device 102 may comprise one or more physical servers or virtual servers hosting one or more networking applications. As an example and not by way of limitation, a server device 102 may comprise part of a larger server system comprising multiple server devices organized as a data center, an edge computing center, or a cloud-computing center. This disclosure contemplates any suitable server device 102. A server device 102 may be accessed by a network user 108 at a client device 104 via the network 106. A client device 104 may enable its user 108 to communicate with other users 108 at the server device 102, such as via messaging applications 118.

In one embodiment, for example, the server device 102 may be implemented as a web server. The web server may be used for linking the connection network platform 112 to one or more of the client devices 104 via a network 106. The web server may include a mail server or other messaging functionality for receiving and routing messages between the connection network platform 112 and one or more client devices 104. An API-request server may allow a gaming platform, a third-party system, a messaging system, and/or an AI system to access information from the connection network platform 112 by calling one or more APIs. An action logger may be used to receive communications from a web server about a user's actions on or off the connection network platform 112. In conjunction with the action log, a third-party-content-object log may be maintained of user exposures to third-party-content objects. A notification controller may provide information regarding content objects to a client device 104. Information may be pushed to a client device 104 as notifications, or information may be pulled from a client device 104 responsive to a request received from a client device 104. Authorization servers may be used to enforce one or more privacy settings of the users of the connections networking system. A privacy setting of a user determines how particular information associated with a user can be shared. The authorization server may allow users to opt in to or opt out of having their actions logged by the connection network platform 112 or shared with other systems (e.g., a third-party system), such as, for example, by setting appropriate privacy settings. Third-party-content-object stores may be used to store content objects received from third parties, such as a third-party system. Location stores may be used for storing location information received from client device 104 associated with users. Advertisement-pricing modules may combine connections information, the current time, location information, or other suitable information to provide relevant advertisements, in the form of notifications, to a user.

The connection network system 100 comprises a connection network platform 112. In particular embodiments, the connection network platform 112 may be part of a network-addressable computing system that can host an online connection network. The connection network platform 112 may generate, store, receive, and send connection networking data, such as, for example, user data 128 (e.g., user-profile data, concept-profile data, etc.), activity data 130 (e.g., user interactions with connection network platform 112), connection graph data 132 (e.g., connections between users or entities), content items 134, or other suitable data related to the online connection network. The connection network platform 112 may be accessed by the other components of the connection network system 100 either directly or via a network 106. As an example and not by way of limitation, a client device 104 may access the connection network platform 112 using the client application 110, which may be a web browser or a native application associated with the connection network platform 112 (e.g., a mobile connection network application, another suitable application, or any combination thereof) either directly or via a network 106.

The connection network platform 112 comprises a security application 114. In particular embodiments, a security application 114 may be an application or electronic device including hardware, software, or embedded logic components or a combination of two or more such components and capable of carrying out the appropriate functionalities implemented or supported by the security application 114. The security application 114 is a network security system that encompasses a suite of technologies, policies, and practices designed to protect the integrity, confidentiality, and availability of data within the connection network platform 112 from unauthorized access, attacks, and other security threats. The security application 114 comprises components such as firewalls, which act as a barrier between trusted and untrusted networks; Intrusion Detection and Prevention Systems (IDPS) that monitor for malicious activity; antivirus and anti-malware software for removing harmful software; and Virtual Private Networks (VPNs) for secure remote access. Additionally, Data Loss Prevention (DLP), email security measures, and encryption are vital for protecting sensitive information and ensuring that only authorized users can access and understand it. Effective network security also requires rigorous access control to restrict network resources to authorized users, alongside Security Information and Event Management (SIEM) systems for real-time security alert analysis. Endpoint security further safeguards devices connected to the network, which are frequent entry points for security threats. The security application 114 implements security practices to ensure a robust defense against a wide array of cyber threats, safeguarding organizational assets and maintaining trust with stakeholders.

The connection network platform 112 comprises a server application 116. In particular embodiments, the server application 116 may be a web server to serve content information, such as content items 134, to the client application 110 of the client device 104. The server device 102 may accept an HTTP request and communicate to a client device 104 one or more HTML files responsive to the HTTP request. The server device 102 may send HTML files representing a webpage with content information for presentation via an electronic display of the client device 104 to the user 108.

In particular embodiments, the server application 116 may be an application operable to provide various computing functionalities, services, and/or resources, and to send data to and receive data from the other entities of the network 106, such as the client device 104, the connection network platform 112, a third-party server, and other electronic devices within the connection network system 100. For example, the server application 116 may be an e-commerce application, a content application, an advertisement application, a web interface, a messaging application, a video application, a webpage, and so forth.

In particular embodiments, the server application 116 may be an application for managing various applications and services provided by the online connection network hosted on the connection network platform 112. In particular embodiments, the server application 116 may include hardware, software, or embedded logic components or a combination of two or more such components for carrying out the appropriate functionalities implemented or supported by connection network platform 112. Although the server device 102 is shown with a single server application 116, it should be noted that this is not by any way limiting and this disclosure contemplates any number of server applications 116.

The connection network platform 112 comprises a messaging application 118. The messaging application 118 is software that enables users to send and receive messages, including text, images, videos, and other multimedia content, over a network 106, such as a local or broad network such as the internet. These applications support real-time communication, allowing immediate message exchange, and typically offer features like group messaging, notifications, and file sharing. They manage user identities, contacts, and groups, while ensuring security through authentication and encryption measures. Designed to operate over various network types, such as Wi-Fi or cellular data, messaging applications can also integrate with other network services and platforms, enhancing their functionality and user experience.

The connection network platform 112 comprises a search application 120. The search application 120 is a software tool that allows users to efficiently locate and retrieve information within the server device 102, such as information for the connection network platform 112 stored by one or more data stores 126. It enables users to search for profiles, job postings, companies, groups, and other professional content. Utilizing algorithms and filters, the search application can sort results based on relevance, connections, industry, job title, location, and other criteria. Key features typically include keyword search, advanced search filters, personalized recommendations, and the ability to save and manage searches. In particular, the search application 120 allows a user to search for content items 134 stored by the data store 126.

The connection network platform 112 comprises various machine learning (ML) models, such as a ranking model 122. A ranking model 122 in machine learning is a ML model designed to order or prioritize a set of items based on their relevance to a given query. Unlike traditional classification or regression models, ranking models output a sorted list of items, making them essential for applications like information retrieval systems, recommendation engines, and search engines. They predict the relevance of each item, employing specialized loss functions and feature engineering to optimize ranking order. Performance is evaluated using metrics such as Mean Reciprocal Rank (MRR) and Normalized Discounted Cumulative Gain (NDCG). Examples include RankNet, LambdaRank, and LambdaMART, which are used by the connection network platform 112 to surface the most relevant results or recommendations to users.

The connection network platform 112 comprises various ML models, such as a recommendation model 124. A recommendation model 124 in machine learning is an ML model designed to predict and suggest items that are likely to be of interest to users, analyzing patterns in user behavior, preferences, and interactions to generate personalized recommendations. These models are widely used in e-commerce, streaming services, and social media to enhance user experience and engagement. Techniques include collaborative filtering, which identifies similarities between users and items based on interactions and feedback, and content-based filtering, which recommends items similar to those a user has shown interest in based on item attributes. Hybrid methods combine multiple approaches to improve accuracy and diversity. Evaluation metrics for recommendation models include precision, recall, Mean Average Precision (MAP), and Normalized Discounted Cumulative Gain (NDCG). Examples include matrix factorization techniques, deep learning approaches like neural collaborative filtering, and graph-based methods, as utilized by platforms such as YouTube, Spotify, and Amazon to provide tailored content and product suggestions.

The server device 102 comprises, or has access to, one or more data stores 126. In particular embodiments, the connections networking system 102 may include a data store 126. The data store 126 may be used to store various types of information for the server device 102 and/or the connection network platform 112. In particular embodiments, the information stored in the data store 126 may be organized according to specific data structures. In particular embodiments, the data store 126 may be a relational, columnar, correlation, or other suitable database. Although this disclosure describes or illustrates particular types of databases, this disclosure contemplates any suitable types of databases. Particular embodiments may provide interfaces that enable a client device 104 or a connection net work system 100 to manage, retrieve, modify, add, or delete, the information stored in the data store 126.

In one embodiment, for example, the data store 126 stores user data 128 for the connection network platform 112. In particular embodiments, the connection network platform 112 may include user data 128 for users of the connection network platform 112. For example, the user data 128 may comprise one or more user profiles. A user profile may include, for example, biographic information, demographic information, behavioral information, social information, professional information, or other types of descriptive information, such as work experience, educational history, hobbies or preferences, interests, affinities, or location. Interest information may include interests related to one or more categories. Categories may be general or specific. The connection information may indicate users who have similar or common work experience, group memberships, hobbies, educational history, or are in any way related or share common attributes. The connection information may also include user-defined connections between different users and content (both internal and external).

In one embodiment, for example, the data store 126 stores activity data 130 for the connection network platform 112. The activity data 130 represents various activities recorded for a user 108 by the connection network platform 112. In particular embodiments, the connection network platform 112 may provide users with the ability to take actions on various types of items or objects supported (or accessible) by connection network platform 112. As an example and not by way of limitation, the items and objects may include groups or connections networks to which users of the connection network platform 112 may belong, events or calendar entries in which a user might be interested, computer-based applications that a user may use, transactions that allow users to apply to job openings or post job openings via the service, interactions with advertisements that a user may perform, content items, online games, or other suitable items or objects. A user may interact with anything that is capable of being represented in the connection network platform 112 or by an external system of a third-party system, which is separate from the server device 102 and coupled to the server device 102 via a network 106.

In one embodiment, for example, the data store 126 stores connection graph data 132 for the connection network platform 112. The connection network platform 112 may store connection graph data 132 for one or more users (e.g., members with subscription accounts) of the connection network platform 112. In one embodiment, for example, connection graph data 132 may be connection data for users organized as a graph. The graph may include multiple nodes, which may include multiple user nodes each corresponding to a particular user or multiple entity nodes each corresponding to a particular entity, such as a business entity. The graph may also have multiple edges connecting the nodes. The connection network platform 112 may provide users of the online connection network system 100 the ability to communicate and interact with other users. In particular embodiments, users may join the online connection network platform 112 via the connection network system 100 and then add connections (e.g., relationships) to a number of other users of the connection network platform 112 to whom they want to be connected. Herein, the term “connection” may refer to any other user of the connection network platform 112 or the connection network system 100 with whom a user has formed a friendship, association, or relationship via the connection network platform 112.

In one embodiment, for example, the data store 126 stores content items 134 for the connection network platform 112. In particular embodiments, the connection network platform 112 also includes user-generated content objects, which may enhance a user's interactions with the connection network platform 112. User-generated content may include anything a user can add, upload, send, message, or “post” to the connection network platform 112. As an example and not by way of limitation, a user communicates posts to the connection network platform 112 from a client device 104. Posts may include data such as status updates or other textual data, articles, job openings, company information, awards, location information, photos, videos, links, music or other similar data or media. Content may also be added to the connection network platform 112 by a third-party through a “communication channel,” such as a newsfeed or content stream.

The connection network system 100 comprises a client device 104. In particular embodiments, a client device 104 may be an electronic device including hardware, software, or embedded logic components or a combination of two or more such components and capable of carrying out the appropriate functionalities implemented or supported by a client device 104. As an example and not by way of limitation, a client device 104 may include a computer system such as a desktop computer, notebook or laptop computer, netbook, a tablet computer, e-book reader, global positioning system (GPS) device, camera, personal digital assistant (PDA), handheld electronic device, cellular telephone, smartphone, wearable device, other suitable electronic device, or any suitable combination thereof. This disclosure contemplates any suitable client device 104. A client device 104 may enable a network user at a client device 104 to access a network 106. A client device 104 may enable its user 108 to communicate with other users 108 at other client devices 104, such as via messaging application 118.

The connection network system 100 comprises a client application 110. In particular embodiments, a client device 104 may include a client application 110, which may be a web browser, and may have one or more add-ons, plug-ins, or other extensions. A user 108 at a client device 104 may enter a Uniform Resource Locator (URL) or other address directing a web browser to a particular server device 102 such as a server or server data center for a connection network platform 112, and the web browser may generate a Hyper Text Transfer Protocol (HTTP) request and communicate the HTTP request to the server device 102. The server device 102 may accept the HTTP request and communicate to a client device 104 one or more Hyper Text Markup Language (HTML) files responsive to the HTTP request. The client device 104 may render a web interface (e.g. a webpage) based on the HTML files from the server for presentation via an electronic display of the client device 104 to the user 108. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as Asynchronous JAVASCRIPT (AJAX), and XML), and the like. Herein, reference to a web interface encompasses one or more corresponding source files (which a browser may use to render the web interface) and vice versa, where appropriate.

In particular embodiments, the client application 110 may be an application operable to provide various computing functionalities, services, and/or resources, and to send data to and receive data from the other entities of the network 106, such as the connection network platform 112. For example, the client application 110 may be a client connection network application tightly integrated with the connection network platform 112, a messaging application 118 for messaging with users 108 of a messaging network or system, a web browser application, an internet searching application, and so forth.

In particular embodiments, the client application 110 may be storable in a memory and executable by a processor circuitry of the client device 104 to render user interfaces, receive user input, send data to and receive data from the connection network platform 112. The client application 110 may generate and present user interfaces to a user via an electronic display of the client device 104. For example, the client application 110 may generate and present a GUI 136 based at least in part on information received from the server device 102, the connection network platform 112, and/or another device or system (e.g., a third party server) via the network 106.

The connection network system 100 comprises a network 106. This disclosure contemplates any suitable network 106. As an example and not by way of limitation, one or more portions of a network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A single network 106 may comprise multiple networks 106.

In operation, a user 108 interacts with a client application 110 of the client device 104 to access applications and services provided by a connection network platform 112 of the server device 102 via one or more links 144 of the network 106. The links 144 may connect each client device 104 to the connection network platform 112 via the network 106. This disclosure contemplates any suitable link 144. In particular embodiments, one or more links 144 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 144 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 144, or a combination of two or more such links 144. Links 144 need not necessarily operate at the same throughout. One or more first links 144 may differ in one or more respects from one or more second links 144.

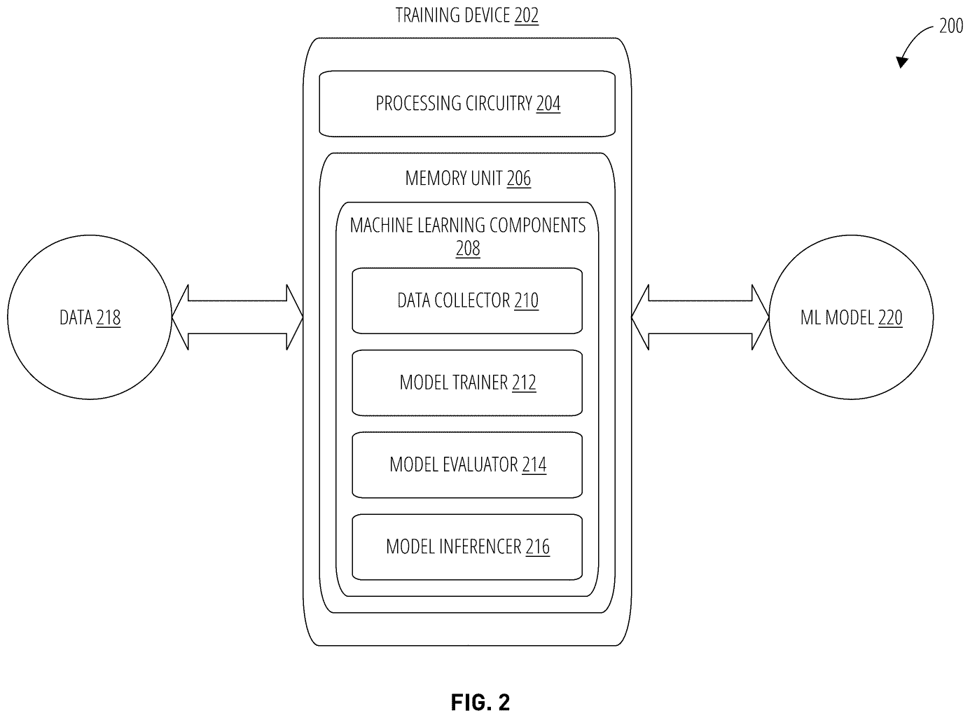

FIG. 2 illustrates an apparatus 200. The apparatus 200 depicts a training device 202 suitable for training an ML model 220 for the connection network system 100. Specifically, the training device 202 trains the ML model 220 to perform inferencing operations in support of the search application 120, ranking model 122, or recommendation model 124.

In one embodiment, the training device 202 trains an ML model 220. In the context of machine learning, “training” refers to the process of teaching a model to recognize patterns and make predictions based on data. This involves initializing the model with initial parameters, which are often set randomly. The model is then provided with a dataset that includes input features and the corresponding correct outputs, often referred to as labels or targets. As the model processes this data, it generates predictions based on its current parameters. The difference between these predictions and the actual target values is measured using a loss function, which quantifies the model's accuracy. The goal is to minimize this loss.

To achieve this, the model's parameters are adjusted using optimization techniques such as gradient descent. By continuously refining these parameters, the model gradually improves its predictions. This cycle of making predictions, calculating the loss, and updating parameters is repeated many times, allowing the model to learn and improve over time. The ultimate aim of training is to produce a model that performs well not just on the training data but also on new, unseen data. This ensures the model's ability to generalize, making it effective in real-world applications.

In various embodiments, the training device 202 may pretrain an ML model 220 before training the ML model 220 or trains a pretrained ML model 220. In the context of machine learning, “pretraining” refers to the initial phase of training a model on a large, general dataset before fine-tuning it on a more specific task or dataset. This approach is particularly common in deep learning, especially with models like neural networks that can benefit from learning basic patterns and representations from broad data before being specialized for a particular application. During pretraining, the model is exposed to a diverse set of data, allowing it to learn fundamental features or representations that are useful across various tasks. For example, in natural language processing, a model might be pretrained on a large corpus of text to understand language structure and grammar. Once the model has acquired this general knowledge, it can be fine-tuned on a smaller, task-specific dataset, such as sentiment analysis or translation. Pretraining is beneficial because it allows the model to start with a good foundation of knowledge, which can lead to better performance and faster convergence during the fine-tuning phase. It also helps when there is limited labeled data for the specific task, as the pretrained model already has a strong understanding from the broader data.

As depicted in FIG. 2, the training device 202 includes a processing circuitry 204 and a memory unit 206. The memory unit 206 may store a set of ML components 208 to support various AI/ML techniques. The ML components 208 comprise a data collector 210, a model trainer 212, a model evaluator 214 and a model inferencer 216.

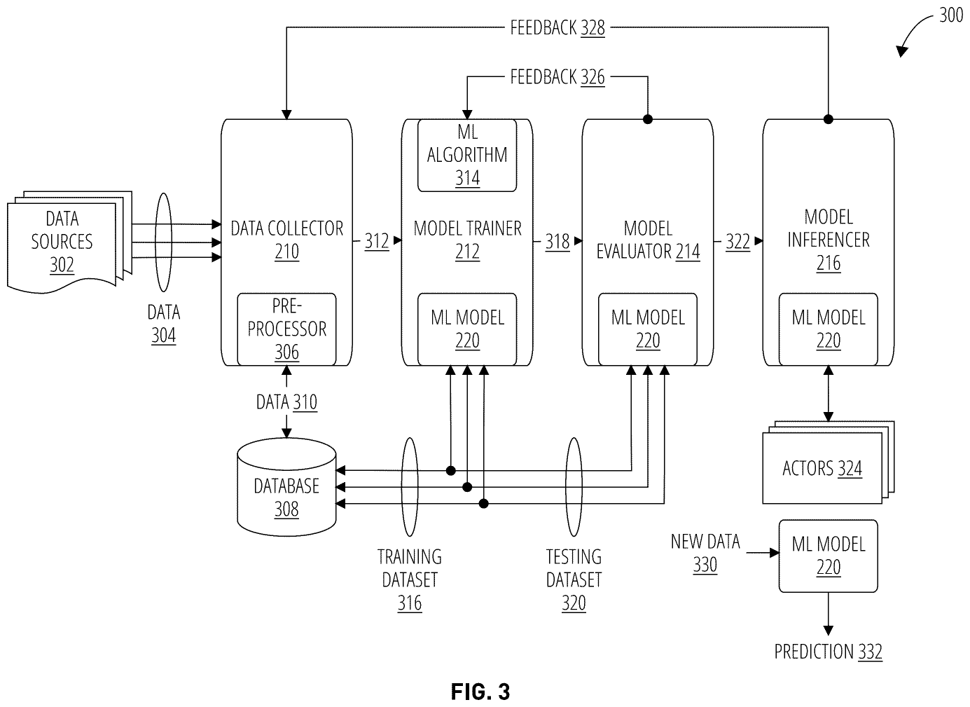

In general, the data collector 210 collects data 218 from one or more data sources to use as training data for a ML model 220. The data collector 210 collects different types of data 218, such as text information, audio information, image information, video information, graphic information, and so forth. The model trainer 212 receives as input the collected data and uses a portion of the collected data as test data for an AI/ML algorithm to train the ML model 220. The model evaluator 214 evaluates and improves the trained ML model 220 using a portion of the collected data as test data to test the ML model 220. The model evaluator 214 also uses feedback information from the deployed ML model 220. The model inferencer 216 implements the trained ML model 220 to receive as input new unseen data, generate one or more inferences on the new data, and output a result such as an alert, a recommendation or other post-solution activity. An exemplary AI/ML architecture for the ML components 208 is described in more detail with reference to FIG. 3.

FIG. 3 illustrates a logic diagram 300 suitable for use by the training device 202 to generate the ML model 220 for deployment by an inferencing device of the connection network platform 112. The logic diagram 300 is an example of a system suitable for implementing various AI techniques and/or ML techniques to perform various training tasks on behalf of the various devices of the connection network system 100.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the logic diagram 300 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 220, evaluate performance of the trained ML model 220, and deploy the tested ML model 220 as the trained ML model 220 in a production environment, and continuously monitor and maintain it.

The ML model 220 is a mathematical construct used to predict outcomes based on a set of input data. The ML model 220 is trained using large volumes of training dataset 316, and it can recognize patterns and trends in the training dataset 316 to make accurate predictions. The ML model 220 is derived from an ML algorithm 314. A data set is fed into the ML algorithm 314 which trains an ML model 220 to “learn” a function that produces mappings between a set of inputs and a set of outputs with a reasonably high accuracy. Given a sufficiently large enough set of inputs and outputs, the ML algorithm 314 finds the function for a given task. This function may even be able to produce the correct output for input that it has not seen during training. A data scientist prepares the mappings, selects and tunes the ML algorithm 314, and evaluates the resulting model performance. Once the ML model 220 is sufficiently accurate on test data, it can be deployed for production use.

The ML algorithm 314 is generally a computational procedure used to identify patterns within data and make inferences or predictions without being explicitly programmed for every scenario. The ML algorithm 314 can process input data, learn from it by adjusting internal parameters, and then apply the learned information to new, unseen data. The ML algorithm 314 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 314 of the logic diagram 300 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 3, the logic diagram 300 includes a set of data sources 302 to source data 304 for the training device 202. Data sources 302 may comprise any device capable generating, processing, storing or managing data 304 suitable for a ML system. Examples of data sources 302 include without limitation databases, web scraping, sensors and Internet of Things (IoT) devices, image and video cameras, audio devices, text generators, publicly available databases, private databases, and many other data sources 302. The data sources 302 may be remote from the training device 202 and accessed via a network, local to the training device 202 and accessed via a network interface, or may be a combination of local and remote data sources 302.

The data sources 302 source difference types of data 304. By way of example and not limitation, the data 304 includes structured data from relational databases, such as customer profiles, transaction histories, or product inventories. The data 304 includes unstructured data from websites such as customer reviews, news articles, social media posts, or product specifications. The data 304 includes data from temperature sensors, motion detectors, and smart home appliances. The data 304 includes image data from medical images, security footage, or satellite images. The data 304 includes audio data from speech recognition, music recognition, or call centers. The data 304 includes text data from emails, chat logs, customer feedback, news articles or social media posts. The data 304 includes publicly available datasets such as those from government agencies, academic institutions, or research organizations. These are just a few examples of the many sources of data that can be used for ML systems. It is important to note that the quality and quantity of the data is critical for the success of a machine learning project.

The data 304 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 302 are communicatively coupled to a data collector 210. The data collector 210 gathers relevant data 304 from the data sources 302. Once collected, the data collector 210 may use a pre-processor 306 to make the data 304 suitable for analysis. This involves data cleaning, transformation, and feature engineering. Data preprocessing is a critical step in ML as it directly impacts the accuracy and effectiveness of the ML model 220. The pre-processor 306 receives the data 304 as input, processes the data 304, and outputs pre-processed data 310 for storage in a database 308. Examples for the database 308 includes a hard drive, solid state storage, and/or random access memory (RAM).

The data collector 210 is communicatively coupled to a model trainer 212. The model trainer 212 performs AI/ML model training, validation, and testing which may generate model performance metrics as part of the model testing procedure. The model trainer 212 receives the pre-processed data 310 as input 312 or via the database 308. The model trainer 212 implements a suitable ML algorithm 314 to train an ML model 1330 on a set of training dataset 316 from the pre-processed data 310. The training process involves feeding the pre-processed data 310 into the ML algorithm 314 to produce or optimize an ML model 220. The training process adjusts its parameters until it achieves an initial level of satisfactory performance.

The model trainer 212 is communicatively coupled to a model evaluator 214. After an ML model 220 is trained, the ML model 220 needs to be evaluated to assess its performance. This is done using various metrics such as accuracy, precision, recall, and FI score. The model trainer 212 outputs the ML model 220, which is received as input 312 or from the database 308. The model evaluator 214 receives the ML model 1330 as input 318, and it initiates an evaluation process to measure performance of the ML model 220. The evaluation process includes providing feedback 326 to the model trainer 212. The model trainer 212 re-trains the ML model 220 to improve performance in an iterative manner.

The model evaluator 214 is communicatively coupled to a model inferencer 216. The model inferencer 216 provides AI/ML model inference output (e.g., inferences, predictions or decisions). Once the ML model 220 is trained and evaluated, it is deployed in a production environment where it is used to make predictions on new data. The model inferencer 216 receives the evaluated ML model 220 as input 322. The model inferencer 216 uses the evaluated ML model 220 to produce insights or predictions on real data, which is deployed as a final production ML model 220. The inference output of the ML model 220 is use case specific. The model inferencer 216 also performs model monitoring and maintenance, which involves continuously monitoring performance of the ML model 220 in the production environment and making any necessary updates or modifications to maintain its accuracy and effectiveness. The model inferencer 216 provides feedback 326 to the data collector 210 to train or re-train the ML model 220. The feedback 326 includes model performance feedback information, which is used for monitoring and improving performance of the ML model 220.

Some or all of the model inferencer 216 is implemented by various actors 324 in the logic diagram 300, including the ML model 220 of the connection network platform 112, for example. The actors 324 use the deployed ML model 220 on new data to make inferences or predictions for a given task, and output a prediction 332. The actors 324 implement the model inferencer 216 locally, or remotely receives outputs from the model inferencer 216 in a distributed computing manner. The actors 324 trigger actions directed to other entities or to itself. The actors 324 provide feedback 328 to the data collector 210 via the model inferencer 216. The feedback 328 comprise data needed to derive training data, inference data or to monitor the performance of the ML model 220 and its impact to the network through updating of key performance indicators (KPIs) and performance counters.

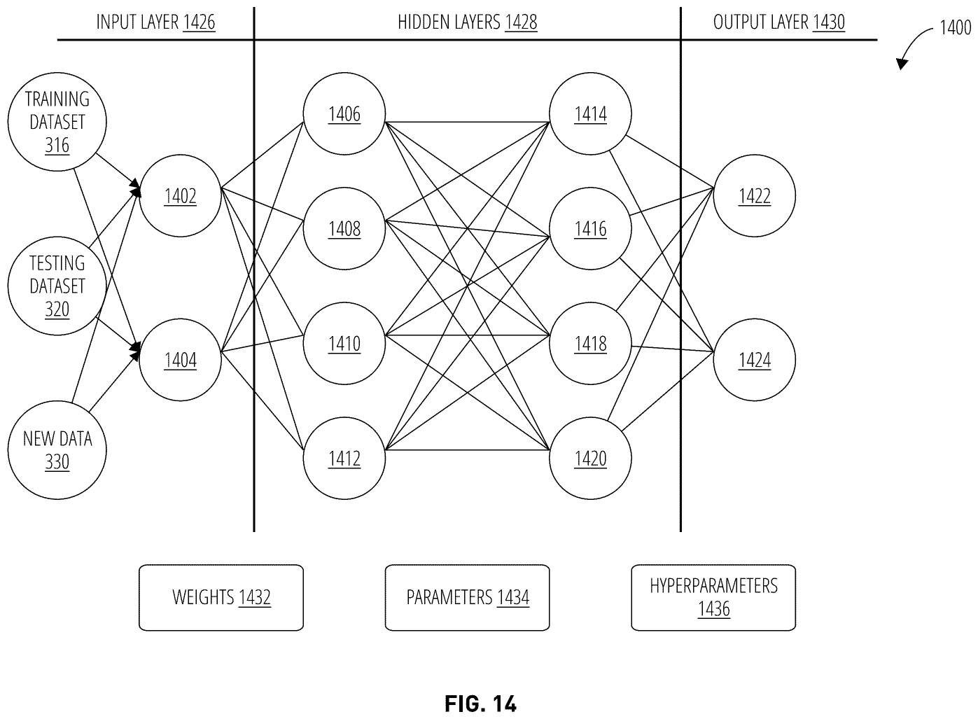

As previously described with reference to FIGS. 1, 2, the connection network system 100 and/or the apparatus 200 may implement some or all of the logic diagram 300 to support various use cases and solutions for various AI/ML tasks. In various embodiments, the training device 202 of the apparatus 200 uses the logic diagram 300 to generate and train the ML model 1330 for use by the connection network platform 112 for the client application 110. In one embodiment, for example, the training device 202 may train the ML model 220 as a neural network, as described in more detail with reference to FIG. 14. Other use cases and solutions for AI/ML are possible as well, and embodiments are not limited in this context.

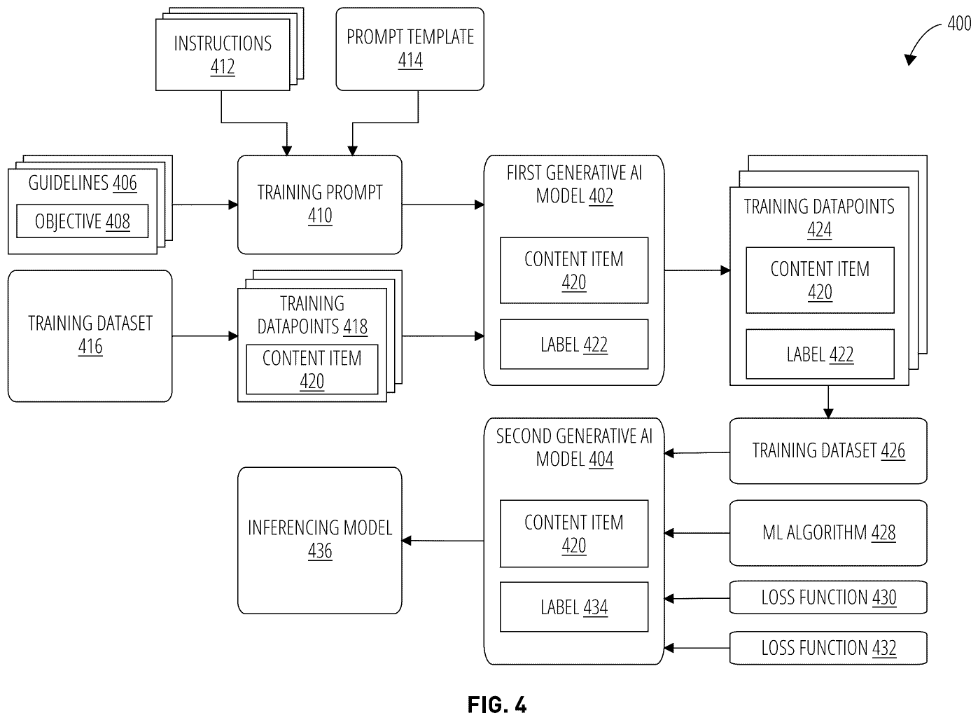

FIG. 4 illustrates a logic diagram 400. The logic diagram 400 is an example of a logic components suitable for implementing the logic diagram 300 by the apparatus 200 for the connection network system 100.

The logic diagram 400 illustrates an example of the training device 202 performing a set of training operations to train various ML models 220. In one embodiment, for example, the training device 202 trains two ML models 220 comprising a first generative AI model 402 and a second generative AI model 404. However, the training device 202 can train more than two ML models 220 for some implementations. Embodiments are not limited in this context.

As depicted in FIG. 4, the logic diagram 400 comprises a first generative AI model 402 and a second generative AI model 404. The first generative AI model 402 and the second generative AI model 404 may be implemented using various network topologies. For example, the first generative AI model 402 and/or the second generative AI model 404 may comprise local models implemented by the training device 202. Alternatively, the first generative AI model 402 and/or the second generative AI model 404 may comprise remote models accessible by the training device 202 and implemented by another device, such as a server device of a cloud computing system. In another example, the first generative AI model 402 is a remote model implemented by a server device of a cloud computing device and the second generative AI model 404 is a local model implemented by the training device 202, or vice-versa. In some embodiments, both models are owned and operated by a single entity, such as a single company. In other embodiments, the first generative AI model 402 is owned and operated by a first entity on a first private network and the second generative AI model 404 is owned and operated by a second entity on a second private network, where the first entity and the second entity are different companies. Embodiments are not limited to a particular network topology or configuration used for the first generative AI model 402 and the second generative AI model 404.

In various embodiments, the first generative AI model 402 and the second generative AI model 404 are both language models. The language models may be of the same or different types. In general, however, the first generative AI model 402 is a larger and more complex language model relative to the second generative AI model 404. In one embodiment, for example, the first generative AI model 402 is a large language model (LLM) having a first set of parameters and a first set of neural network layers. The second generative AI model 404 is also an LLM having a second set of parameters and a second set of neural network layers. The LLM of the second generative AI model 404 utilizes fewer parameters and neural network layers relative to the LLM of the first generative AI model 402, and is therefore much more efficient. For example, the first set of parameters for the first generative AI model 402 is greater than the second set of parameters for the second generative AI model 404. In another example, the first set of neural network layers for the first generative AI model 402 is greater than the second set of neural network layers for the second generative AI model 404.

Some non-limiting examples for the first generative AI model 402 include larger transformer models, such as a generative pretrained transformer (GPT) (e.g., a version of ChatGPT), a text-to-text transfer transformer (T5), XLNet, Megatron language model (LM), Turing natural language generation (NLG), big science large open-science open-access multilingual language model (BL0OM), and enhanced representation through knowledge integration (ERNIE). Some non-limiting examples for the second generative AI model 404 include medium transformer models, such as a bidirectional encoder representations from transformers (BERT) or robustly optimized BERT (ROBERTa). Other examples for the second generative AI model 404 include smaller transformer models, such as a decoding-enhanced BERT with disentangled attention (DeBERTa) or a distilled BERT (DistilBERT). Embodiments are not limited to these examples.

In various embodiments, the training device 202 uses the first generative AI model 402 to train the second generative AI model 404 in a manner similar to a teacher model and student model paradigm. A teacher model and a student model are concepts used in knowledge distillation, a technique in machine learning to transfer information from a larger, more complex model to a smaller, more efficient one. The teacher model is a pretrained, often large and complex model that serves as the source of knowledge. The teacher model usually has high performance and accuracy due to its extensive capacity and depth. It typically generates soft labels or predictions (e.g., probabilistic outputs) used to instruct the student model. The student model is a smaller, less complex model that is trained to mimic the behavior and performance of the teacher model. The student model learns from the soft labels produced by the teacher model, often achieving competitive performance with significantly reduced computational requirements. The process of training a student model using the outputs and guidance from a teacher model is called “knowledge distillation.” This technique enables the deployment of efficient, real-time applications on devices with limited resources while maintaining a high level of performance.

In one embodiment, for example, the first generative AI model 402 is implemented as a teacher model and the second generative AI model 404 is implemented as a student model. A training device 202 uses knowledge distillation to train the second generative AI model 404 as a student model using the first generative AI model 402 as a teacher model. The training device 202 generates a first training prompt 410 for a first generative AI model 402. The first training prompt 410 comprises a first set of guidelines 406 for a network service 146 of a connection network platform 112 of a connection network system 100. The first set of guidelines 406 define an objective 408 for the network service 146. The first generative AI model 402 receives the first training prompt 410 and a first set of training datapoints 418 from a first training dataset 316. The first generative AI model 402 generates a second set of training datapoints 418 for a second training dataset 316 based on the first training prompt 410 and the first set of training datapoints 418. An ML algorithm 314 trains a second generative AI model 404 using the second set of training datapoints 424 from the second training dataset 426. The training device 202 deploys the second generative AI model 404 to perform inferencing operations for the network service 146 in accordance with the objective 408.

Although the training device 202 utilizes a teacher model and student model paradigm, in some cases the first generative AI model 402 generates hard labels rather than soft labels. In the context of student-teacher models, “hard labels” and “soft labels” refer to different types of supervisory signals used during the training process. Hard labels are traditional, discrete classification labels that indicate the correct class without providing information about the relative confidence in other classes. For example, given an image classification task with categories like cats, dogs, and birds, a hard label might be {Cat, Dog, Bird}, where an image of a dog would simply be labeled as “Dog.” Hard labels are derived directly from the original training data and represent absolute ground truth. Soft labels are probability distributions over classes that indicate the relative likelihood of each class as predicted by a teacher model. Soft labels provide more nuanced information about the uncertainty and relationships between different classes. For example, for the same image classification task, a soft label might be a probability distribution such as {Cat: 0.1, Dog: 0.85, Bird: 0.05}. Soft labels are generated by the teacher model and are used to transfer knowledge to the student model by capturing more information about class similarities and uncertainties.

A key difference between hard labels and soft labels is that hard labels offer a single, definitive class, while soft labels offer a spectrum of probabilities across multiple classes. Hard labels and soft labels also have different training dynamics. Soft labels help the student model learn more about the decision boundaries and class relationships, potentially leading to better generalization and performance, especially with limited data. Hard labels are simpler but less informative. In knowledge distillation, soft labels from the teacher model help guide the student model to understand and replicate the more detailed and nuanced decision-making process of the teacher, leading to improved performance. However, using the teacher model to output hard labels allows for the automatic generation of labels for the training datapoints 418, thereby avoiding the need to manually generate labels for the training datapoints 418. It is also simplifies training the student model to better match outputs between the teacher model and the student model, thereby reducing an amount of time needed to train the student model.

In one embodiment, for example, the training device 202 generates a first training prompt 410 based on a first set of guidelines 406 for a network service 146 of a connection network system 100. The first set of guidelines 406 define one or more objectives 408 for the network service 146. In one embodiment, for example, the training device 202 generates the training prompt 410 using a set of information comprising the first set of guidelines 406, a set of one or more instructions 412 for the first generative AI model 402, and/or a prompt template 414. The training device 202 sends the first training prompt 410 and a first set of training datapoints 418 from a first training dataset 316 to a first generative AI model 402. A training datapoint of the first set of training datapoints 418 may comprise a content item 420 without a label for the content item 420. The training device 202 receives a second set of training datapoints 424 for a second training dataset 426 from the first generative AI model 402. A training datapoint of the training datapoints 424 of the second training dataset 426 comprises a first label 422 for the content item 420 generated by the first generative AI model 402 based on the objective 408. The training device 202 trains a second generative AI model 404 using the second set of training datapoints 424 from the second training dataset 426 using a loss function 430.

The training device 202 continues to train the second generative AI model 404 until a terminating condition is reached. An example of a terminating condition is the second generative AI model 404 generates a second label 434 that corresponds to the first label 422 for the content item 420 based on the objective 408. In general, the term “correspond” involves a relationship where two things are in agreement, alignment, or communication with each other. In various embodiments, for example, the term “correspond” means: (1) an exact match; (2) a close similarity; (3) agreement in nature, function, or form; or (4) equivalent or parallel in position, time, or value. Another example of a terminating condition is the second generative AI model 404 generates a second label 434 that is the same as the first label 422 for the content item 420 based on the objective 408. In other words, the label 422 and the label 434 are a direct match. Yet another example of a terminating condition is the second generative AI model 404 generates a second label 434 that is similar to the first label 422 for the content item 420 based on the objective 408. In this case, the label 422 and label 434 are within a defined threshold such as a percentage match. Other terminating conditions may be defined as a hyperparameter such as a time, epoch, date, and so forth. Embodiments are not limited to these examples.

In various embodiments, the first generative AI model 402 generates training datapoints 424 for a training dataset 426 using a training prompt 410. A prompt for an LLM is a piece of text or a sequence of tokens used to initiate a model learning process on a specific task or domain. The LLM uses the prompt to learn how to process different types of inputs and produce relevant outputs. Prompts can vary in complexity and are crafted to help the model improve its performance on a wide range of tasks, from answering questions to generating coherent narratives. A training prompt 410 is a specific type of prompt that provides context and constraints to guide the first generative AI model 402 (e.g., a teacher model) to generate training data for the second generative AI model 404 (e.g., a student model). The training prompt 410 includes a clear instruction and context to ensure that the generated training datapoints 424 are useful for training the second generative AI model 404.

In one embodiment, for example, the training device 202 generates the training prompt 410 using a first set of guidelines 406. The first set of guidelines 406 define one or more objectives 408 for the network service 146. For example, a first guideline from the first set of guidelines 406 may define a first objective 408 for a first network service 146 and a second guideline from the first set of guidelines 406 may define a second objective 408 for the first network service 146 or a second network service 146. In one embodiment, for example, a guideline comprises a series of natural language processing (NLP) instructions in a chain of thought (CoT) format or query to instruct the first generative AI model 402 on how to determine a result consistent with a given objective 408 for a target item associated with the objective. Examples of target items may comprise content, a content item, an article, a recommendation, a product, a service, a connection from connection graph data 132, an advertisement, a job posting, a school, a company, an online course, and other content associated with a connection network platform 112 of a connection network system 100. In one embodiment, for example, a target item may comprise a content item 420 for a training datapoint of the first set of training datapoints 418.

NLP instructions comprise words, sentences, or paragraphs of text written in a natural language (e.g., English, Spanish, French, Korean, etc.) that guide the first generative AI model 402 to perform NLP tasks expressed by the objective 408, such as sentiment analysis, language translation, speech recognition, and text summarization. Examples of NLP instructions include expressions in a natural language such as a directive, an imperative, a request, a query, a definition, a rule, a guideline, a suggestion, an objective, a condition, and other forms of expression. The NLP instructions assist the first generative AI model 402 to capture context and semantics in a written language for a given NLP task. For example, an NLP instruction may be structured as a series of sentences describing a task or objective, or a context for a task or objective. An example of an NLP instruction may have the following format: “You are an intelligent assistant that can determine a <objective name> for a <network service> for an online connection network system.” In one example, assume the <objective name> is a quality level of a content item (e.g., a post) for a given search query and the <network service> is a search service. An example of an NLP instruction using the example format may comprise: “You are an intelligent assistant that can determine a quality of a post for a given search query for an online connection network system. The definition of quality depends on a category of the search query. In general we have the following query categories: company name, skill or title, knowledge seeking, newsy.” An NLP instruction may have any type of information structured in any particular format suitable for a given implementation. Embodiments are not limited to this example.

In one embodiment, for example, the first set of guidelines 406 may comprise a series of one or more NLP instructions for the first generative AI model 402 presented in a CoT format. A CoT format in machine learning breaks down a complex problem into a series of intermediate, logical steps, leading to the final solution. The CoT format aims to mimic human reasoning, where solving a problem involves addressing various components methodically. For example, a CoT format may comprise different sections, including an initial query, one or more intermediate steps, and a final solution. The CoT format may include an initial query which is the problem or question that requires solving. The CoT format also includes a series of one or more intermediate steps to provide directions or examples guiding the first generative AI model 402 to decompose the problem in a step-by-step manner. The CoT format may also include a final solution, which is an answer derived by the first generative AI model 402 after logically processing the intermediate steps. An example of a CoT format to solve a mathematical problem may comprise: “Query: If a train travels at a speed of 60 miles per hour for 3 hours and then at 80 miles per hour for 2 hours, what is the total distance covered? Chain of Thought: Step 1: Calculate the distance traveled in the first 3 hours at 60 miles per hour. (60 miles/hour*3 hours=180 miles); Step 2: Calculate the distance traveled in the next 2 hours at 80 miles per hour. (80 miles/hour*2 hours=160 miles); Step 3: Add the distances from both segments to get the total distance. (180 miles+160 miles=340 miles); Final Solution: The total distance covered is 340 miles.” By following this structured approach, the CoT format helps the first generative AI model 402 improve its reasoning abilities and generate more accurate and interpretable responses.

The first set of guidelines 406 may comprise one or more NLP instructions for the first generative AI model 402 presented in a CoT format to generate training datapoints 424 for the training dataset 426 according to an objective 408. As previously discussed, a guideline defines an objective 408 for a network service 146. An objective 408 is tailored or specifically designed for a given network service 146. For example, assume an objective 408 is a budget objective of an advertisement for a network service 146 such as an advertisement service that selects advertisements to present to users 108 based on demographic information. In another example, assume an objective 408 is a search objective of a content item for a network service 146 such as a search service that returns search results with content items relevant to a search query. The guidelines 406 may include guidelines with different objectives 408 for different network services 146. In other words, a first objective 408 for a first network service 146 may be different from a second objective 408 for a second network service 146. When a new objective 408 is defined for a network service 146, the guidelines 406 may be updated with the new guideline with the new objective 408 for the network service 146.

The NLP instructions in the CoT format for the first generative AI model 402 may be designed to guide the first generative AI model 402 with a reasoning framework to allow the first generative AI model 402 to arrive at a result that is consistent with a given objective 408 for a given network service 146. By way of example, assume a guideline from the first set of guidelines 406 defines an objective 408 as a search objective of a content item for a network service 146 such as a search service that returns search results with content items relevant to a search query. Further assume the objective 408 is a quality objective for a content item suitable for inclusion in the search results. The guideline may include NLP instructions in a CoT format such as: “For search queries of <category>, a content item is considered high quality when it is similar to <list of high quality examples>, medium quality when it is similar to <list of medium examples>, and low quality when it is similar to <list of low quality examples>.” For example, assume a search query is a company name category, a CoT prompt may comprise “For search queries of a company name category, a content item is considered high quality when it is similar to a post about a company's products and services, medium quality when it is similar to a post about a company's state of incorporation, and low quality when it is similar to an open job position for the company.” Embodiments are not limited to this example.

In one embodiment, for example, the training device 202 generates the training prompt 410 using a set of information comprising the first set of guidelines 406 and a set of one or more instructions 412 for the first generative AI model 402. As previously described, a guideline comprises NLP instructions associated with an objective 408 for a network service 146. For example, a guideline comprises a series of one or more NLP instructions in a CoT format to instruct the first generative AI model 402 on how to determine a given objective 408 for a content item 420 of a training datapoint from the training datapoints 418. Similarly, the instructions 412 for the first generative AI model 402 comprise a series of one or more NLP instructions. Further, the instructions 412 are associated with a given training task. For example, the instructions 412 are specific NLP instructions for generating the second training datapoints 424 of the second training dataset 426 using the first training datapoints 418 of the first training dataset 416.

Continuing with the previous example, assume a guideline from the first set of guidelines 406 defines an objective 408 as a search objective of a content item for a network service 146 such as a search service that returns search results with content items relevant to a search query. Further assume the objective 408 is a quality objective for a content item suitable for inclusion in the search results. An example for the instructions 412 to generate training datapoints 424 for training dataset 426 may include: “I will provide you with a QUERY, a POST, and POST AGE. First, classify the QUERY to one of the categories: {company name, skill or title, knowledge seeking, newsy}. Then, use QUERY category to select the right guideline for evaluating the POST from the guidelines above. Last, use the selected guideline to determine POST quality and classify the post into one of the following graded relevance categories {0, 1, 2}. 2 means high quality, 1 means medium quality, and 0 is low quality. The output will be one number: 0, 1, or 2. Only respond with the score, do not say any word or explain.” Embodiments are not limited to this example.

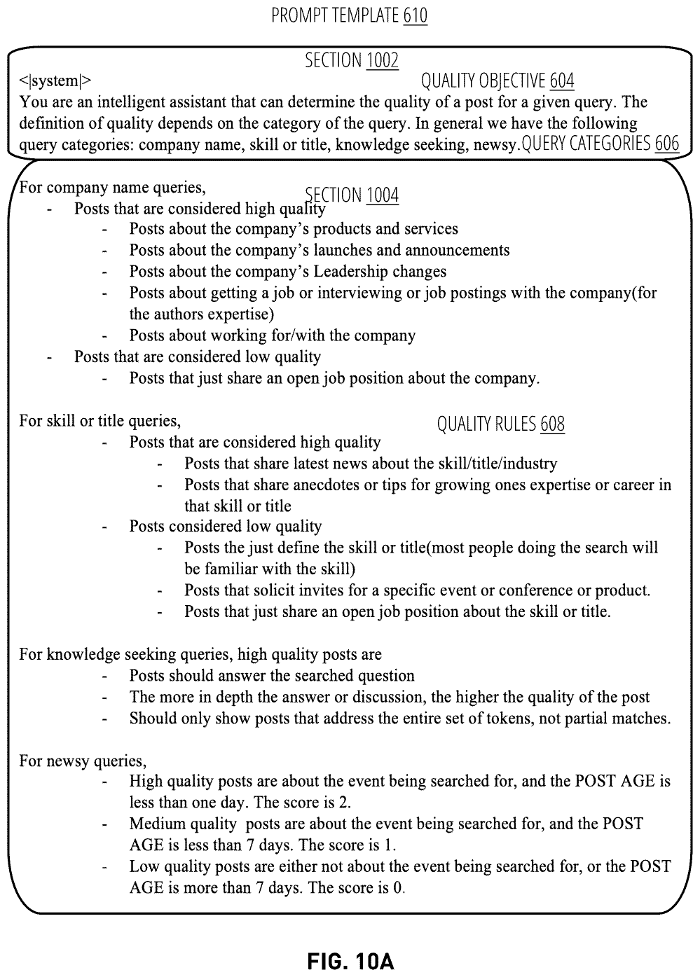

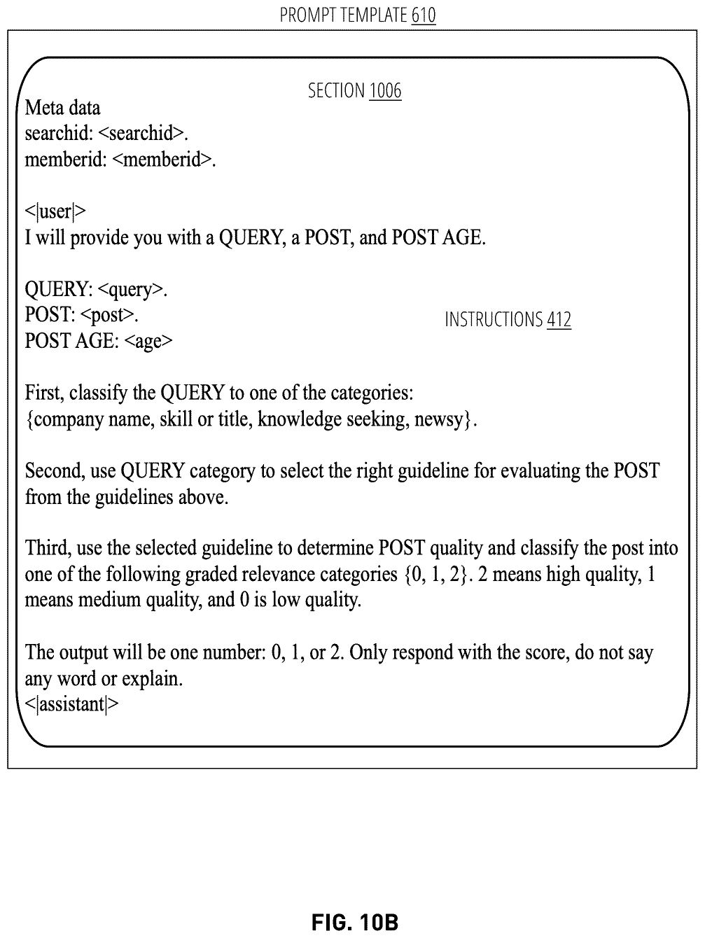

In one embodiment, for example, the training device 202 generates the training prompt 410 using a set of information comprising the first set of guidelines 406, a set of one or more instructions 412 for the first generative AI model 402, and a prompt template 414. A prompt template 414 is a predefined framework or structure used to standardize inputs, outputs, or the formatting of data for the training prompt 410. The prompt template 414 helps ensure consistency, reproducibility, and efficiency in various tasks, such as generating the training prompt 410. It provides a consistent format, reducing the chances of errors and making collaborative work more straightforward. In one embodiment, for example, the prompt template 414 comprises structures, information elements, or fields for inserting information from the guidelines 406, the objective 408, and the instructions 412. The training device 202 then generates a training prompt 410 with this information in a format specified by the prompt template 414. A specific example of a prompt template 414 is illustrated and described with reference to FIG. 10A and FIG. 10B.

For example, assume a training prompt 410 is for generating a quality metric for a content item. The training prompt 410 may include one or more guidelines 406. A guideline from the guidelines 406 may comprise one or more instructions 412 for generating a quality metric for the first generative AI model 402 and a set of rules defining different levels of quality for content items. In one embodiment, for example, a guideline from the first set of guidelines 406 comprises a series of NLP instructions 412 in a CoT format to determine a quality level of a content item. In one embodiment, for example, the training device 202 may use a prompt template 414 to assist in generating the training prompt 410. The prompt template 414 may comprise an outline and information elements (e.g., fields) that can be populated with information from the guidelines 406 and the instructions 412 to quickly and easily generate the training prompt 410.

In a particular embodiment, a guideline from the first set of guidelines 406 defines an objective 408 such as a quality objective for a network service 146 such as a search application 120. In this case, the guideline comprises a series of NLP instructions in a CoT format to determine a quality level of a content item as represented by a quality metric. The training device 202 retrieves or receives the guideline from the first set of guidelines 406. The first generative AI model 402 determines a quality level of the content item 420 in the training datapoint from the first training dataset 416 using the series of NLP instructions from the guideline. In one embodiment, for example, the training datapoints 418 include content items 420 without any labels. In this case, the first generative AI model 402 generates a first label 422 representing the quality level of the content item 420 in the training datapoint from the first training dataset 416. The first generative AI model 402 adds the first label 422 for the content item 420, and it outputs the training datapoint as a training datapoint of the training datapoints 424 for the second training dataset 426.

In a particular embodiment, the training device 202 may use a two phase training process when training the second generative AI model 404. In a first phase, the ML algorithm 314 of the training device 202 may pretrain the second generative AI model 404 using the first set of training datapoints 418 from the first training dataset 316 and a first loss function 430. In a second phase, the ML algorithm 314 of the training device 202 may then train the pretrained second generative AI model 404 using the second set of training datapoints 424 from the second training dataset 426 and a second loss function 432. Non-limiting examples of a loss function include loss functions suitable for a generative AI model, such as Cross-Entropy Loss, Maximum Likelihood Estimation (MLE), Kullback-Leibler (KL) Divergence, Reconstruction Loss, and Perplexity, among others. In one embodiment, the loss function 430 and the loss function 432 are the same. In one embodiment, the loss function 430 and loss function 432 are different.

Specifically, the ML algorithm 314 of the training device 202 trains the second generative AI model 404 using knowledge distillation. For example, assume the first generative AI model 402 is a teacher model that is first trained on a very large dataset using standard training techniques and loss functions, such as cross-entropy loss. Once trained, the first generative AI model 402 processes the first training dataset 416 to generate soft labels or hard labels. The soft labels are probability distributions over the classes which provide more information about a confidence level in each prediction. The hard labels are discrete class labels assigned to each datapoint (e.g., one-hot encoded class labels) without providing information about the relative likelihoods of the other classes. During training, the ML algorithm 314 of the training device 202 defines a distillation loss. A distillation loss function is typically a combination of a traditional loss function (e.g., cross-entropy loss on the true labels) and the distillation loss, which measures the difference between the student output and the teacher soft labels or hard labels. The distillation loss may employ Kullback-Leibler (KL) divergence. When using soft labels, temperature scaling is used to soften the output probabilities. The outputs of both the teacher and student models are divided by a temperature parameter T before applying a SoftMax function. Higher temperatures produce softer probability distributions. During training, both models use this adjusted temperature, but in deployment, the standard temperature (T=1) is used. Further assume the second generative AI model 404 is a student model that is a smaller or less complex neural network relative to the first generative AI model 402. The ML algorithm 314 of the training device 202 trains the second generative AI model 404 to minimize the combined loss. This process involves computing the traditional cross-entropy loss between the label 434 made by the second generative AI model 404 and the label 422 made by the first generative AI model 402. The ML algorithm 314 of the training device 202 computes a KL divergence (e.g., distillation loss) between the label 422 and the label 434. The ML algorithm 314 of the training device 202 combines these two losses, often using a weight factor to balance them. The ML algorithm 314 of the training device 202 updates weights for the second generative AI model 404 through an optimization algorithm (e.g., stochastic gradient descent, Adam) to minimize the combined loss. By training in this manner, the second generative AI model 404 learns from the hard labels and/or soft labels, leading to a more efficient and often equally effective model with reduced computational requirements.

In a particular embodiment, a guideline defines an objective 408 as a quality objective and a network service 146 as a search service for the connection network platform 112 of the connection network system 100. In this case, the ML algorithm 314 of the training device 202 retrieves a training datapoint from the second training dataset 426. The training datapoint comprises a search query 138, a content item 420, and a first label 422 for the content item 420. The ML algorithm 314 of the training device 202 generates an input vector for the second generative AI model 404. The input vector comprises a classification token (CLS) and a concatenation of the search query 138 and the content item 420 separated by a separator token (SEP). The second generative AI model 404 generates a second label 434 for the content item 420 based on the input vector. The ML algorithm 314 of the training device 202 determines a difference between the first label 422 and the second label 434 for the content item 420. The ML algorithm 314 of the training device 202 modifies one or more parameters (e.g., weights or biases) for the second generative AI model 404 based on the difference using a loss function 430 and/or loss function 432, such as a cross-entropy loss function, a KL loss function, or a combination of both.

The use of guidelines 406, instructions 412, and prompt template 414 allow for training the ML model 220 for a given set of objectives in a flexible and dynamic manner. For example, when an objective 408 for a network service 146 changes, the guidelines 406 and/or instructions 412 are updated with the new objective 408, and the training device 202 generates a new training prompt 410 based on the new guidelines 406 and/or new instructions 412 using the prompt template 414. The first generative AI model 402 receives the new training prompt 410 and the first set of training datapoints 418 from the first training dataset 416 as input, and it generates a new set of training datapoints 424 for a new training dataset 426. The training device 202 then re-trains the second generative AI model 404 using the new training dataset 426 to perform inferencing operations in accordance with the new objective 408.

In one embodiment, for example, the training device 202 generates a second training prompt 410 for the first generative AI model 402. The second training prompt is based on a second set of guidelines 406 for the network service 146 or a new network service 146 of the connection network system 100. The second set of guidelines define a new objective 408 for the network service 146. The training device 202 sends the second training prompt 410 and a first set of training datapoints 418 from a first training dataset 416 to the first generative AI model 402. The first generative AI model 402 generates and sends a third set of training datapoints 424 for a third training dataset 426 to the training device 202. The training device 202 receives the third training dataset 426 from the first generative AI model 402, and the ML algorithm 314 of the training device 202 trains the second generative AI model 404 using the third set of training datapoints 424 from the third training dataset 426 using the loss function 430 and/or loss function 432.

In various embodiments, once the second generative AI model 404 is trained, the training device 202 deploys the trained second generative AI model 404 as an inferencing model 436. For example, the training device 202 deploys the inferencing model 436 to an inferencing device. An example of an inferencing device is the server device 102 implementing the connection network platform 112 of the connection network system 100. The server device 102 may execute the inferencing model 436 to perform inferencing operations in support of one or more network services 146 of the connection network platform 112, such as the security application 114, the server application 116, the messaging application 118, the search application 120, the ranking model 122, and/or the recommendation model 124. In one embodiment, for example, the inferencing model 436 is deployed to support the search application 120.

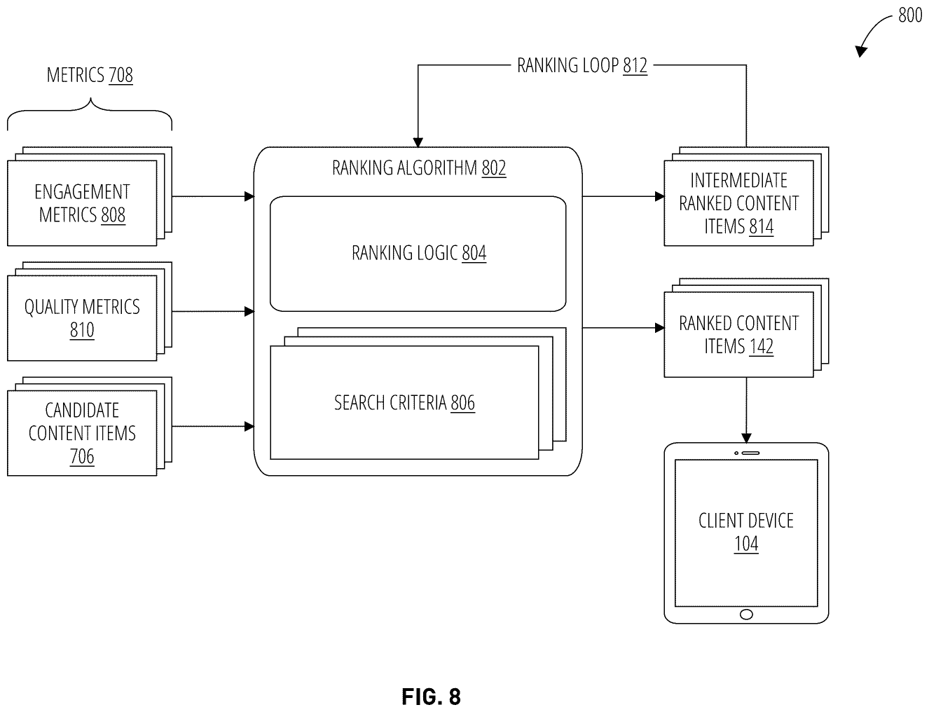

In one embodiment, for example, the inferencing model 436 (e.g., a trained version of the second generative AI model 404) performs inferencing operations for the search application 120. In this case, the search application 120 receives a search query 138, and it retrieves a set of content items 134 in response to the search query 138. The second generative AI model 404 generates a quality metric for each content item in the set of content items 134 based on the search query 138. The search application 120 and/or the ranking model 122 rank the set of content items 134 based on the quality metric to form a set of ranked content items 142. The connection network platform 112 causes presentation of the ranked content items 142 on a graphical user interface (GUI) of an electronic device, such as GUI 136 on a touchscreen of the client device 104. A more detailed example of this implementation is described with reference to FIG. 8.

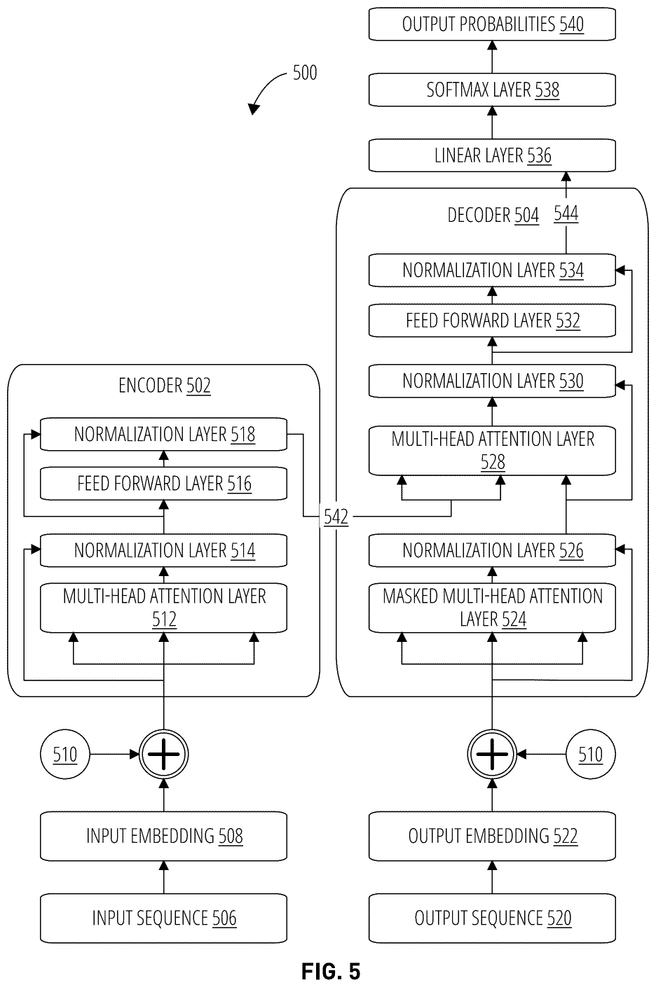

FIG. 5 illustrates a transformer model 500. The transformer model 500 is an example of a transformer architecture suitable for use by the first generative AI model 402 and/or the second generative AI model 404. In particular, the transformer model 500 is an example of a transformer architecture suitable for GPT, such as a version of ChatGPT. ChatGPT is trained on massive amounts of data, allowing it to generate text and respond to various prompts with human-like precision and accuracy. Embodiments are not limited to transformers.

As depicted in FIG. 5, the transformer model 500 comprises an encoder 502 and a decoder 504. The encoder 502 receives as input an input sequence 506, which is converted to an input embedding 508. A positional encoding 510 is added to the input embedding 508. The input embedding 508 with positional encoding 510 is input to the encoder 502. The encoder 502 comprises a multi-head attention layer 512, a normalization layer 514, a feed forward layer 516, and a normalization layer 518. The encoder 502 outputs an encoder output 542 to the decoder 504. The decoder 504 receives as input an output sequence 520, which is converted to an output embedding 522. A positional encoding 510 is added to the output embedding 522. The output embedding 522 with positional encoding 510 is input to the decoder 504. The decoder 504 comprises a masked multi-head attention layer 524, a normalization layer 526, a multi-head attention layer 528, a normalization layer 530, a feed forward layer 532, and a normalization layer 534.

Specifically, the encoder 502 is a neural sequence transduction model comprising an encoder 502 and a decoder 504. The encoder 502 receives an input sequence 506 and it translates the input sequence 506 into a lower-dimensional space. The encoder 502 maps an input sequence of symbol representations (x₁, . . . , xₙ) to a sequence of continuous representations z=(z₁, . . . , Zₙ). Given z, the decoder 504 then generates an output sequence (y₁, . . . , yₘ) of symbols one element at a time. At each step, the model is auto-regressive, consuming the previously generated symbols as additional input when generating the next. The decoder 504 translates the lower-dimensional data provided by the encoder 502 back to the original data format. Both the encoder 502 and the decoder 504 share three main types of layers, including a positional encoding layer, self-attention layer, and feedforward layer.

The encoder 502 transforms natural language input into numerical vectors. The encoder 502 receives an input sequence 506. The input sequence is a sequence of tokens (e.g., words or sub-words) that represent the text input. An input encoding layer of the encoder 502 converts the input sequence 506 into an input embedding 508. An input embedding 508 is a numerical representation of concepts converted to number sequences. The input embedding 508 is an NLP technique that represents words with vectors in such a way that once represented in a vectorial space, the mathematical distance between vectors is representative of the similarity among words they represent. For example, the search application 120 may incorporate input embeddings to personalize, recommend, and search content. The input embedding 508 may comprise a matrix of vectors, where each vector represents a token in the sequence. The input embedding layer maps each token to a high-dimensional vector that captures the semantic meaning of the token.

Positional encoding 510 is a fixed, learned vector that represents a position of a word in the input sequence. It is added to the input embedding 508 so that the final representation of a word includes both its meaning and its position. Positional encoding is a technique used in transformer architectures, such as those employed by ChatGPT, to provide information about the relative positions of tokens in the input sequence. Since transformers do not inherently recognize the order of tokens due to their attention mechanism, positional encoding is crucial for enabling the model to consider sequence structure. To capture the order of the tokens in the input sequence, a positional encoding is added to the input embedding 508. The positional encoding is a vector that represents the position of each token in the sequence.

The encoder 502 includes multiple self-attention layers. The self-attention layers are responsible for determining the importance of each input token in generating the output. The self-attention layer allows the model to compute relationships between different parts of the input sequence 506. In order to obtain a self-attention vector for a sentence, the self-attention layer uses query, key, and value matrices. These matrices are used to calculate attention scores between the elements in the input sequence and are three weight matrices that are learned during the training process. In the query, key, and value computations, the input vectors are transformed into three different representations using linear transformations. In an attention computation operation, the model computes a weighted sum of the values, where the weights are based on the similarity between the query and key representations. The weighted sum represents the output of the self-attention mechanism for each position in the sequence.

The encoder 502 uses a multi-head attention layer 512. The multi-head attention layer 512 uses multiple self-attention layers operating in parallel on different parts of the input data, producing multiple representations. The multi-head attention layer 512 allows the model to focus on different parts of the input sequence and compute relationships between them in parallel. In each head, the query, key, and value computations are performed with different linear transformations, and the outputs are concatenated and transformed into a new representation. The output of the multi-head self-attention mechanism is fed into a feed forward layer 516.

The feed forward layer 516 comprises a series of fully connected layers and activation functions. The feed forward layer 516 transforms the output of the multi-head attention layer 512 into a suitable representation for the final output. The feed forward layer 516 is a fully connected layer, also known as a dense layer, where every neuron in the layer is connected to every neuron in the preceding layer. An activation function is a non-linear function that is applied to the output of the fully connected layer. The activation function introduces non-linearity into the output of a neuron, which allows the network to learn complex patterns and relationships in the input data. An example of an activation function is a rectified linear unit (ReLu) activation function. The output of the feed forward layer 516 is used as input to the next layer in the encoder 502.

The encoder 502 may also comprise a number of normalization layers, such as a normalization layer 514 and a normalization layer 518. The activations in each layer of the transformer architecture are normalized using layer normalization, which helps stabilize the training process and prevent the model from overfitting. A residual connection followed by layer normalization helps to stabilize the training process and make the model easier to train. The output of the normalization layer 518 is the final output from the encoder 502 and it is a vector representation of the input sequence 506. The final output from the normalization layer 518 is used as input to the multi-head attention layer 528 of the decoder 504.

The decoder 504 decodes the input sequence 506 to the original data format. Similar to the encoder 502, the decoder 504 shares the core elements of positional encoding, self- attention, and feedforward layers. As depicted in transformer model 500, the decoder 504 comprises a masked multi-head attention layer 524, a normalization layer 526, a multi-head attention layer 528, a normalization layer 530, a feed forward layer 532, and a normalization layer 534. The decoder 504 outputs a decoder output 544 to a linear layer 536. The linear layer 536 is a feedforward network that adapts the dimension of the input to the dimension of the output. The output of the linear layer 536 feeds into a softmax layer 538. The softmax layer 538 transforms the input into a vector of probabilities. The output of the softmax layer 538 is a set of an output probabilities 540 for the transformer model 500. The transformer model 500 then picks the word corresponding to the highest probability and uses it as a best output of the model.

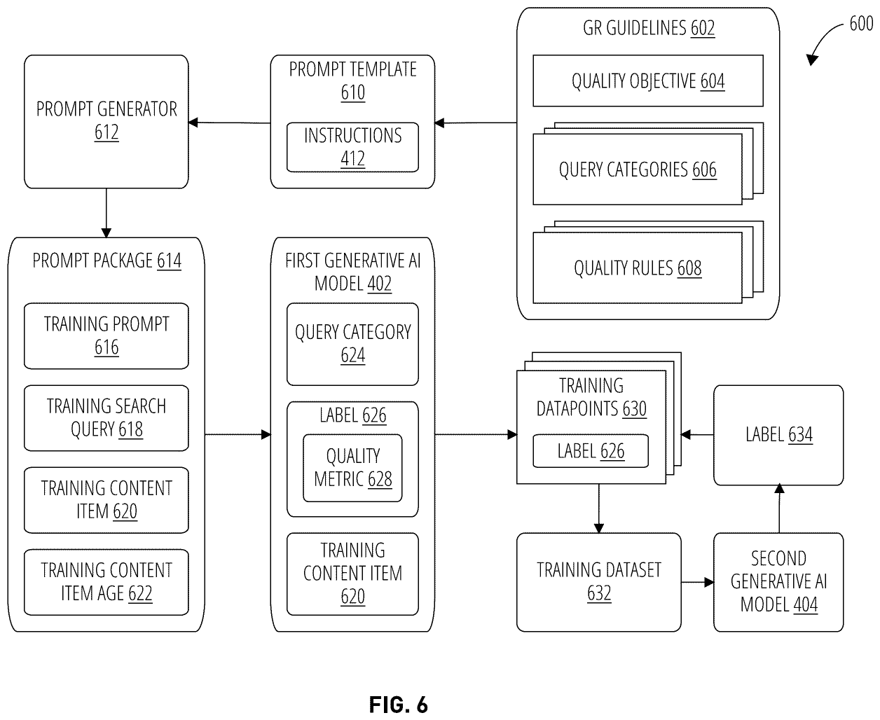

FIG. 6 illustrates a logic diagram 600. The logic diagram 600 is an example of a set of logical components suitable for prompting a first generative AI model 402 to generate training datapoints 630 for a training dataset 632 for training a second generative AI model 404. Specifically, the logic diagram 600 is for prompting the first generative AI model 402 to generate training datapoints 630 for the training dataset 632 in accordance with a quality objective 408 to support a search application 120 as a network service 146 of the connection network platform 112 of the connection network system 100. The trained second generative AI model 404 is then deployed as an inferencing model 436 to support the search application 120 of the connection network platform 112 of the connection network system 100.

Similar to the logic diagram 400 described with reference to FIG. 4, the logic diagram 600 uses a first generative AI model 402 and a second generative AI model 404. In one embodiment, for example, the first generative AI model 402 is a larger transformer-based model, such as a GPT or T5. In one embodiment, for example, the second generative AI model 404 is a smaller transformer-based model, such as a bidirectional encoder representations from transformers (BERT) or a variant of a BERT such as decoding-enhanced BERT with disentangled attention (DeBERTa).

The ML algorithm 314 of the training device 202 trains the second generative AI model 404 and it deploys the second generative AI model 404 as the inferencing model 436. In one embodiment, for example, the inferencing model 436 is designed to support a search application 120 of a connection network platform 112 for a connection network system 100. The search application 120 is particularly designed to search for content items 134 accessible by the connection network system 100. The connection network system 100 stores the content items 134 in data stores 126 or provides access to content items 134 stored by third party systems via a set of application program interfaces (APIs). The search application 120 searches for content items 134 based on various search objectives as defined by the guidelines 406 and associated objectives 408. Non-limiting examples of objective 408 include engagement, quality, accuracy, speed, relevance, personalization, and so forth.

In order to better train the second generative AI model 404 to support the search application 120, the training device 202 crafts a custom prompt package 614 for the first generative AI model 402 that causes the first generative AI model 402 to generate training datapoints 630 for a training dataset 632 in accordance with one or more objectives 408 for the search application 120. An objective 408 is defined using a custom set of guidelines 406, referred to as graded relevance (GR) guidelines, such as GR guidelines 602.

The GR guidelines 602 define an objective 408 as a quality objective 604 for a network service 146 comprising a search service delivered via the search application 120. The quality objective 604 is defined by a set of query categories 606 and quality rules 608. The query categories 606 are different categories for a search query, such as a search query 138. The quality rules 608 comprise a set of NLP instructions with examples of different levels of quality associated with a given content item relative to a given category (e.g., a topic) of a search query. The GR guidelines 602 define a set of query categories 606 for a search query. A query category represents a general topic of a search query. Non-limiting examples of query categories 606 for a search query may include a company name, a job title, a job skill, knowledge seeking, news, and other topics. The GR guidelines 602 also define a set of quality rules 608 for each query category in the set of query categories 606. A quality rule comprises a specific attribute, condition, criterion, property, characteristic, or standard associated with a content item that is needed to meet a given level of quality within each query category. The level of quality is defined by a quality scale, such as a set of numerical values representing different levels of quality. For example, a quality scale may have three defined quality levels of low, medium, and high represented by numerical values 0, 1, and 2, respectively (e.g., 0=low quality, 1=medium quality, 2=high quality). Embodiments are not limited to this example.

The generative AI model trainer 212 generates a training dataset 632 based on the GR guidelines 602. In one embodiment, for example, the first generative AI model 402 is a transformer-based neural network, such as a generative pretrained transformer (GPT) model. The first generative AI model 402 receives as input a prompt package 614. The prompt package 614 comprises a training prompt 616, a training search query 618, a training content item 620, and a training content item age 622. The training device 202 generates the training prompt 616 using a prompt template 610 encoded with the GR guidelines 602. The first generative AI model 402 receives the training prompt 616 as input. It also receives as input a training search query 618, a training content item 620, and one or more properties or attributes associated with a content item (e.g., age), such as training content item age 622, and other types of inputs.

Once the first generative AI model 402 receives the prompt package 614, it analyzes the training search query 618 based on the training prompt 616 to determine a query category 624 for the training search query 618. The first generative AI model 402 then generates a label 626 for the training content item 620 based on the query category 624 and instructions from the training prompt 616. In one embodiment, for example, the label 626 comprises a quality metric 628 for the training content item 620 relative to the query category 624. The quality metric 628 is a value that represents a level of quality of a content item relative to a search query based on a defined quality scale. This information is added as a training datapoint of the training datapoints 630 for the training dataset 632. This process is repeated until the first generative AI model 402 generates enough training datapoints 630 sufficient to train the second generative AI model 404 for inferencing operations on new data to determine whether a content item is relevant to a search query.

Once the first generative AI model 402 generates sufficient training datapoints 630 for the training dataset 632 based on the GR guidelines 602, the ML algorithm 314 trains the second generative AI model 404 using the training dataset 632 generated by the first generative AI model 402. The training device 202 trains the second generative AI model 404 using the training datapoints 630 from the training dataset 632 to perform inferencing operations in support of a search application 120. For this type of network service, the training device 202 uses the ML algorithm 314 to train the second generative AI model 404 by retrieving a training datapoint from the training datapoints 630 from the training dataset 632. The training datapoint comprises a training search query 618, a training content item 620, and a label 626 for the training content item 620 as generated by the first generative AI model 402. The second generative AI model 404 generates a label for the training content item 620. The training device 202 compares the label for the training content item 620 and the label 626 generated by the first generative AI model 402 using a loss function, using a process similar to the training process described with reference to FIG. 4.

In various embodiments, the training device 202 trains the second generative AI model 404 to generate a label 634 that matches the label 626 generated by the first generative AI model 402. In one embodiment, for example, the training device 202 generates an input vector for the second generative AI model 404. The input vector comprises a classification token (CLS) and a concatenation of the training search query 618 and the training content item 620 separated by a separator token (SEP). The second generative AI model 404 generates a classification label for the content item based on the input vector. The second generative AI model 404 compares the label 634 (e.g., a classification label) to the label 626 (e.g., a classification label) generated by the first generative AI model 402 (e.g., label 626. The ML algorithm 314 then modifies one or more parameters for the second generative AI model 404 based on results of the comparison and a loss function, such as a cross-entropy loss function, for example.

The trained second generative AI model 404 is deployed as an inferencing model 436 to perform inferencing operations for a search application 120 of a connection network platform 112 of a connection network system 100. For example, the inferencing model 436 receives as input a search query 138 and a content item from the content items 134, and it generates a quality metric 628 for the content item relative to the search query 138 based on the GR guidelines 602. A search application 120 uses the quality metric 628 to identify content items 134 suitable for addition to a search result. The search application 120 and/or a ranking model 122 ranks the identified content items 134 within the search results. The connections network system 1300 may use the quality metric 628 to improve and enhance other network services 146 offered by the connections connection network platform 112, such as providing recommendations for advertisements, job postings, connection suggestions, and other types of network services 146.

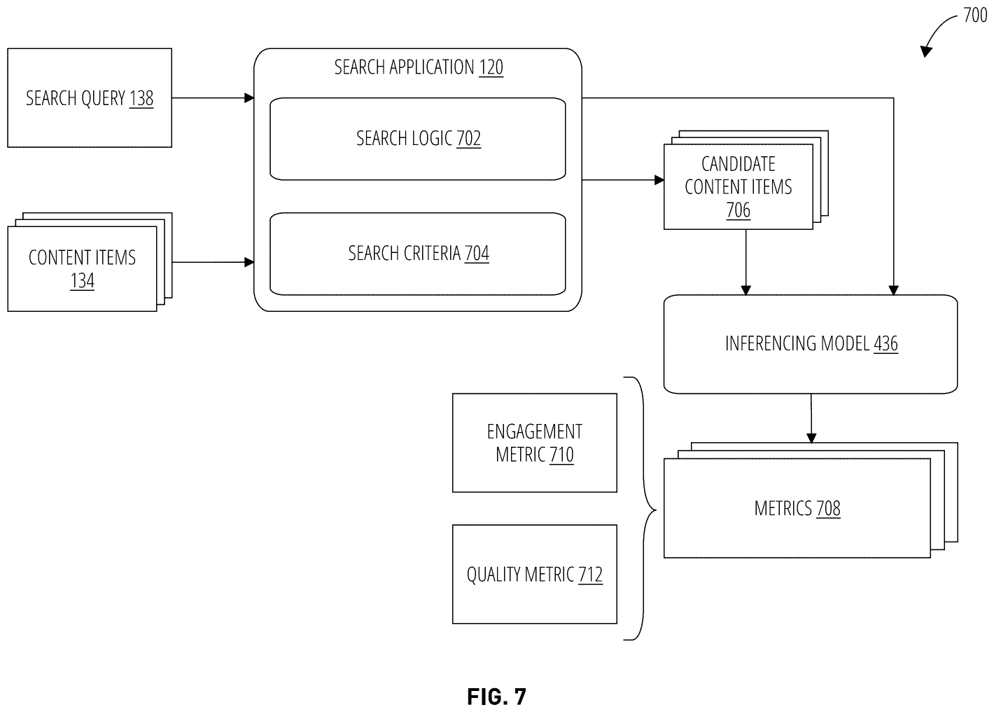

FIG. 7 illustrates a logic diagram 700. The logic diagram 700 is an example of a set of logical components suitable for implementing an inferencing model 436 comprising a trained second generative AI model 404 to support a search application 120 of a connection network platform 112 of a connection network system 100.

As previously described, the ML algorithm 314 of the training device 202 trains the second generative AI model 404 and it deploys the second generative AI model 404 as the inferencing model 436. In one embodiment, for example, the inferencing model 436 is designed to support a search application 120 of a connection network platform 112 for a connection network system 100. The search application 120 is particularly designed to search for content items 134 accessible by the connection network system 100. The connection network system 100 stores the content items 134 in data stores 126 or provides access to content items 134 stored by third party systems via a set of application program interfaces (APIs). The search application 120 searches for content items 134 based on various search objectives as defined by the guidelines 406 and associated objectives 408. Non-limiting examples of objective 408 include engagement, quality, accuracy, speed, relevance, personalization, and so forth.

In one embodiment, for example, the search application 120 searches for content items 134 or ranks content items 134 based on a set of metrics 708. The metrics 708 may include one or more engagement metrics 710 and one or more quality metrics 712. An engagement metric 710 is a measurement or score representative of a level of engagement between a user 108 and one or more content items 134. For example, the engagement metric 710 is generated using activity data 130 of one or more users 108. Note the user 108 may comprise a same user 108 that submits the search query 138 or a different user 108 of the connection network platform 112. Similar to the quality metrics 628, a quality metric 712 is a measurement or score representative of a level of quality of one or more content items 134 relative to a search query 138 as defined by a set of guidelines 406. The search application 120 may implement search logic 702 and search criteria 704. The search logic 702 searches for candidate content items 706 that fit the search criteria 704. The search query 138 and the candidate content items 706 are outputted from the search application 120.

The inferencing model 436 receives the search query 138 and the candidate content items 706. The inferencing model 436 generates a set of metrics 708 for the candidate content items 706 based on the search query 138. In one embodiment, for example, the metrics 708 comprise an engagement metric 710 and a quality metric 712. The search application 120 may use the metrics 708 to search or further refine the search for a set of candidate content items 706 provided by the connection network system 100 in response to a search query 138. For example, the search application 120 and/or the ranking model 122 filters or ranks the set of candidate content items 706 based on the engagement metric 710 and/or quality metric 712. The search logic 702 selects a subset of the ranked candidate content items 706 to form a set of ranked content items 142. The search application 120 returns a search result with the set of ranked content items 142 for presentation on the GUI 136 of the client device 104.

FIG. 8 illustrates a logic diagram 800. The logic diagram 800 is an example of a ranking algorithm 802 suitable for use by the search application 120 and/or the ranking model 122 to rank a set of candidate content items 706 based on a set of metrics 708 generated for the set of candidate content items 706.

In a particular embodiment, for example, the inferencing model 436 comprising the trained second generative AI model 404 supports a search application 120. For instance, the search application 120 receives a search query 138 from a user 108 via a GUI 136 of the client device 104 via the network 106. The search application 120 performs a search for content items 134 in the data store 126. The inferencing model 436 receives a set of content items 134 in response to the search query 138. The inferencing model 436 generates a set of metrics 708 for one or more of the content items 134 based on the search query 138, such as candidate content items 706. In one embodiment, the metrics 708 may comprise a set of engagement metrics 808 and a set of quality metrics 810 for the candidate content items 706.

The search application 120, the ranking model 122, and/or the inferencing model 436 may implement a ranking algorithm 802. The ranking algorithm 802 ranks the candidate content items 706 based on one or more engagement metrics 808, one or more quality metrics 810, and a set of search criteria 806. For example, the ranking algorithm 802 ranks the candidate content items 706 based on the engagement metrics 808, the quality metrics 628, or a combination of both. In some cases, the ranking algorithm 802 implements a ranking loop 812 for the candidate content items 706 in one or more iterations. For example, the ranking algorithm 802 may perform a first pass using a first set of search criteria 806 to generate a first set of intermediate ranked content items 814. The ranking algorithm 802 may perform a second pass using a second set of search criteria 806 to generate a second set of intermediate ranked content items 814. This process may continue in an iterative fashion until a terminating condition is reached.

The search application 120 selects a number from the candidate content items 706 or a final set of intermediate ranked content items 814 that are ranked highest using the metrics 708, such as defined number of candidate content items 706 or defined percentage of candidate content items 706, as the final set of content items 134. The search application 120 causes presentation of the ranked content items 142 on the GUI 136 of the client device 104. A user 108 may then select and inspect a content item from the ranked content items 142 on the GUI 136.

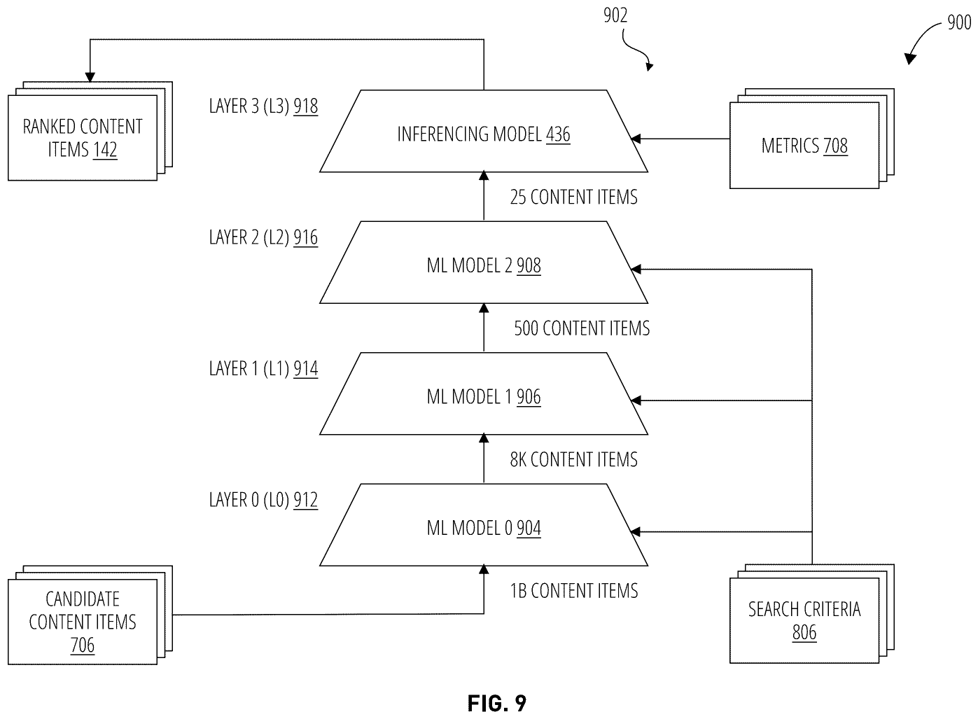

In one embodiment, for example, the search application 120 searches for a set of candidate content items 706 in response to the search query 138 using a layered architecture. The use of a layered architecture increases speed and reduces latency to produce a search result while maintaining a high level of performance. For example, the search application 120 may use a first MLP to search for a set of candidate content items 706 in response to the search query 138 based on a first set of search criteria. The search application 120 selects a subset of candidate content items 706 from the set of candidate content items 706 using a second MLP based on a second set of search criteria. The search application 120 sends the subset of candidate content items 706 as a final set of content items 134 to the second generative AI model 404 for final ranking. A more detailed example of a layered architecture for search application 120 is described with reference to FIG. 9.

FIG. 9 illustrates a logic diagram 900. The logic diagram 900 is an example of a layered architecture 902 suitable for implementation by the search application 120. Although the layered architecture 902 illustrates four layers and four ML models, it may be appreciated that the layered architecture 902 may include any number of layers and any number of ML models of any type as needed for a given implementation. Embodiments are not limited to the example shown in logic diagram 900.

As previously discussed, in some embodiments, an inferencing model 436 such as the trained second generative AI model 404 may be implemented with other ML models in a layered architecture 902. The layered architecture 902 is an ML framework comprising multiple layers L, where each layer L comprises a different ML model, where L represents any positive integer. For example, assume the layered architecture 902 comprises four layers (e.g., L=4) comprising a layer 0 (L0), layer 1 (L1), layer 2 (L2), and layer 3 (L3), designated in logic diagram 900 as L0 912, L1 914, L2 916, and L3 918. In one embodiment, for example, the inferencing model 436 may be implemented as a final layer (e.g., L3 918) in a series of layers (e.g., L0 912, L1 914, and L2 916) for searching and ranking content items 134, where each previous layer (e.g., L0-L2) uses different ML models to successively narrow a number of content items before the inferencing model 436 at L3 918 produces a final search result.

In one embodiment, for example, the ML models for layers L0 912, L1 914, and L2 916 may be implemented as multi-objective perceptrons (MLPs), such as ML model 0 904, ML model 1 906, and ML model 2 908, respectively. In this case, the search application 120 may use the MLPs of layers L0-L2 to retrieve different sets of content items 134 in response to the search query 138, where each successive layer outputs a reducing number of content items 134.

By way of example, the ML model 0 904 of L0 912 may receive as input a set of candidate content items 706 from the content items 134. For example, assume the candidate content items 706 comprise 1 billion content items 134. The ML model 0 904 of the L0 912 may analyze the candidate content items 706 according to a first set of search criteria 806, and it outputs a top 8000 content items 134. The ML model 1 906 of the L1 914 receives as input the 8000 content items 134, analyzes the 8000 content items 134 according to a second set of search criteria 806, and it outputs a top 500 content items 134. The ML model 2 908 of L2 916 receives as input the 500 content items 134, analyzes the 500 content items 134, and it outputs a top 25 content items. The inferencing model 436 of the L3 918 receives the 25 content items as input, analyzes the 25 content items based on the metrics 708, and it outputs a final set of ranked content items 142. Embodiments are not limited to this example.

In one embodiment, for example, the search application 120 searches for a set of candidate content items 706 in response to the search query 138 using a layered architecture comprising only two layers. For example, a first MLP based on a first set of search criteria. The search application 120 selects a subset of candidate content items 706 from the set of candidate content items 706 using a second MLP based on a second set of search criteria. The search application 120 sends the subset of candidate content items 706 as the set of content items 134 to the second generative AI model 404.

FIG. 10A and FIG. 10B illustrate a prompt template 610 suitable for the logic diagram 600. FIG. 10A illustrates an example of a quality objective 604, a set of query categories 606, and a set of quality rules 608 encoded into a prompt template 610. FIG. 10B illustrates an example of instructions 412 encoding into the prompt template 610. Embodiments are not limited to these examples.

As previously described with reference to FIG. 6, the training device 202 generates a prompt package 614 comprising a training prompt 616 using a prompt template 610 and a set of GR guidelines 602. The GR guidelines 602 define a quality objective 604 for a search application 120, a set of query categories 606 for a search query 138, and a set of quality rules 608. The prompt template 610 may be encoded with the GR guidelines 602, the quality objective 604, the query categories 606, and the quality rules 608. The training device 202 uses the prompt template 610 to generate the training prompt 616.

As depicted in FIG. 10A, a section 1002 comprises an example of NLP instructions defining a quality objective 604 and a set of query categories 606. For example, the NLP instructions comprise a series of sentences describing a task or objective, or a context for a task or objective. An example of an NLP instruction using the example format comprises a quality objective 604, stating: “You are an intelligent assistant that can determine a quality of a post for a given query.” The NLP instruction may further define query categories 606, stating: “The definition of quality depends on the category of the query. In general we have the following query categories: company name, skill or title, knowledge seeking, newsy.” A section 1004 comprises an example of NLP instructions in a CoT format for a set of quality rules 608. The NLP instructions in a CoT format follow a pattern such as: “For search queries of <category>, a content item is considered high quality when it is similar to <list of high quality examples>, medium quality when it is similar to <list of medium examples>, and low quality when it is similar to <list of low quality examples>.” For example, when a search query 138 is determined to be a company name query, a CoT prompt may comprise “For company name queries, posts that are considered high quality including posts about the company's products and services.” For low quality posts, the CoT prompt may further defined “Posts that are considered low quality, posts that just share an open position about the company.” Embodiments are not limited to these examples.

FIG. 10B illustrates an example of instructions 412 encoding into the prompt template 610. Embodiments are not limited to these examples. Specifically, FIG. 10B depicts a section 1006 comprising an example of a set of instructions 412 suitable for the prompt template 610.

As described with reference to FIG. 4, assume a guideline from the first set of guidelines 406 defines an objective 408 as a quality objective of a content item for a network service 146 such as a search application 120 that returns search results with content items 134 relevant to a search query 138. Further assume the objective 408 is a quality objective for a content item 420 suitable for inclusion in the search results. An example for the instructions 412 to generate training datapoints 424 for training dataset 426 using the prompt template 610 may include “<|user|> I will provide you with a QUERY, a POST, and POST AGE. QUERY: <query>. POST: <post>. POST AGE: <age>. First, classify the QUERY to one of the categories: {company name, skill or title, knowledge seeking, newsy}. Second, use QUERY category to select the right guideline for evaluating the POST from the guidelines above. Third, use the selected guideline to determine POST quality and classify the post into one of the following graded relevance categories {0, 1, 2}. 2 means high quality, 1 means medium quality, and 0 is low quality. The output will be one number: 0, 1, or 2. Only respond with the score, do not say any word or explain. <|assistant|>”. Embodiments are not limited to this example.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all acts illustrated in a logic flow may be required in some embodiments. In addition, the given logic flow may be implemented by a hardware clement, a software element executed by a processor, or any combination thereof. The embodiments are not limited in this context.

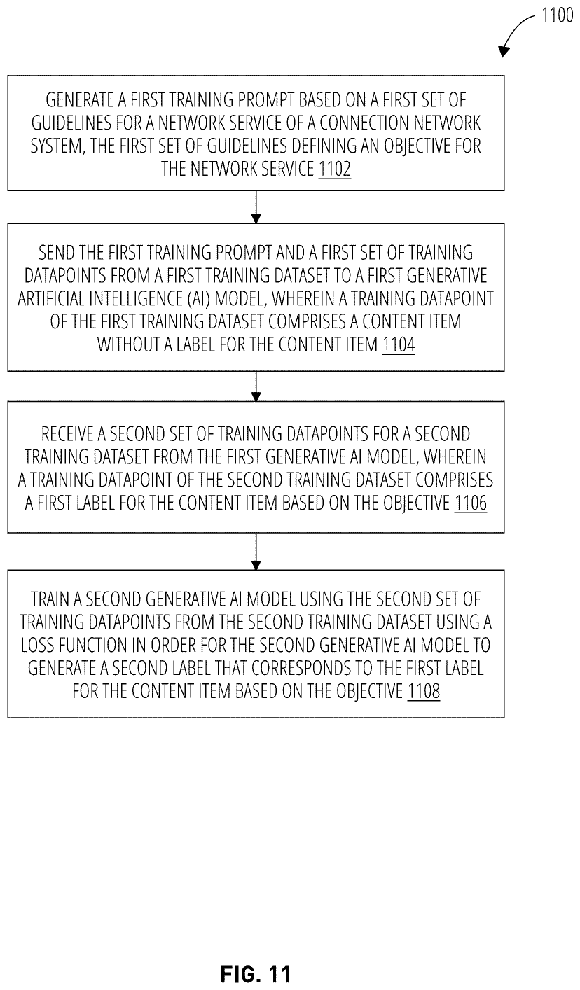

FIG. 11 illustrates an embodiment of a logic flow 1100. The logic flow 1100 may be representative of some or all of the operations executed by one or more embodiments described herein. For example, the logic flow 1100 may include some or all of the operations performed by devices or entities within the connection network platform 112 of the connection network system 100, such as the server device 102 and/or the client device 104. More particularly, the logic flow 1100 illustrates an example where the server device 102 performs a set of training and/or inferencing operations of a ML model such as a generative AI model to support one or more network services 146 provided by the connection network platform 112 of the connection network system 100. For example, the logic flow 1100 may be performed by the server device 102 and/or the client device 104 using a logic diagram 300, logic diagram 400, transformer model 500, logic diagram 600, logic diagram 700, logic diagram 800, or logic diagram 900.

As depicted in logic flow 1100, a block 1102 generates a first training prompt based on a first set of guidelines for a network service of a connection network system, the first set of guidelines defining an objective for the network service. A block 1104 sends the first training prompt and a first set of training datapoints from a first training dataset to a first generative artificial intelligence (AI) model, a training datapoint from the first set of training datapoints comprising a content item without a label for the content item. A block 1106 receives a second set of training datapoints for a second training dataset from the generative AI model, wherein a training datapoint of the second training dataset comprises a first label for the content item generated by the first generative AI model based on the objective. A block 1108 trains a second generative AI model using the second set of training datapoints from the second training dataset using a loss function in order for the second generative AI model to generate a second label that corresponds to the first label for the content item based on the objective.

By way of example, a training device 202 generates a first training prompt 410 based on a first set of guidelines 406 for a network service 146 of a connection network system 100. The first set of guidelines 406 define an objective 408 for the network service 146. The training device 202 sends the first training prompt 410 and a first set of training datapoints 418 from a first training dataset 416 to a first generative AI model 402. In one embodiment, for example, a training datapoint from the first set of training datapoints comprises a content item 420 without a label for the content item 420. The training device 202 receives a second set of training datapoints 424 for a second training dataset 426 from the first generative AI model 402, wherein a training datapoint of the second training dataset 426 comprises a first label 422 for the content item 420 generated by the first generative AI model 402 based on the objective 408. The ML algorithm 314 of the training device 202 trains a second generative AI model 404 using the second set of training datapoints 424 from the second training dataset 426 using a loss function 430 and/or loss function 432 in order for the second generative AI model 404 to generate a second label 434 that corresponds to the first label 422 for the content item 420 based on the objective 408.

In one embodiment, for example, a guideline from the first set of guidelines 406 defines a quality objective 604 for the network service 146, the guideline comprising a series of natural language processing (NLP) instructions in a chain of thought (CoT) format to determine a quality level of a content item 420.

In one embodiment, for example, training device 202 retrieves a guideline from the first set of guidelines 406, the guideline comprising a series of NLP instructions in a CoT format, and the first generative AI model 402 determines a quality level of the content item 420 in the training datapoint from the first training dataset 416 using the series of NLP instructions from the guideline. In one embodiment, for example, the training datapoint from the training dataset 416 does not include a label for the content item 420. The first generative AI model 402 generates the first label 422 representing the quality level of the content item 420 in the training datapoint from the first training dataset 416. The first generative AI model 402 adds the first label 422 for the content item 420 to the training datapoint for the second training dataset 426.

In one embodiment, for example, the training device 202 may train the second generative AI model 404. The ML algorithm 314 of the training device 202 may pretrain the second generative AI model 404 using the first set of training datapoints 418 from the first training dataset 416 and a first loss function 430. After pretraining is complete, the ML algorithm 314 of the training device 202 may train the pretrained second generative AI model 404 using the second set of training datapoints 424 from the second training dataset 426 and a second loss function 432.

In one embodiment, for example, the first set of guidelines 406 define a quality objective 604 for a search service supported by search application 120 of the connection network platform 112 of the connection network system 100. The training device 202 retrieves the training datapoint from the second training dataset 426. The training datapoint comprises a training search query 618, a training content item 620, and a first label 626 (e.g., similar to label 422) for the training content item 620. The ML algorithm 314 of the training device 202 generates an input vector for the second generative AI model 404. The input vector comprises a classification token (CLS) and a concatenation of the training search query 618 and the training content item 620 separated by a separator token (SEP). The second generative AI model 404 generates a second label 634 (e.g., similar to label 434) for the training content item 620 based on the input vector. The ML algorithm 314 of the training device 202 determines a difference (e.g., a residual) between the first label 626 and the second label 634 for the training content item 620. The ML algorithm 314 of the training device 202 modifies one or more parameters for the second generative AI model 404 based on the difference using a loss function 432, such as cross-entropy loss function, for example.

In one embodiment, for example, the first generative AI model 402 is a large language model (LLM) having a first set of parameters and a first set of neural network layers, and the second generative AI model is a LLM having a second set of parameters and a second set of neural network layers, where the first set of parameters is greater than the second set of parameters or the first set of neural network layers are greater than the second set of neural network layers.

In one embodiment, for example, the training device 202 generates a second training prompt 410 for the first generative AI model 402. The second training prompt is based on a second set of guidelines 406 for the network service 146 or another network service 146 of the connection network system 100. Similar to the first set of guidelines 406, the second set of guidelines 406 also define an objective 408 for the network service 146, where a first objective 408 from the first set of guidelines 406 is different from a second objective 408 from the second set of guidelines 406. For example, the first objective 408 may comprise a quality objective and the second objective 408 is an engagement objective. The training device 202 sends the second training prompt 410 and a first set of training datapoints 418 from a first training dataset 416 to the first generative AI model 402. The training device 202 receives a third set of training datapoints 424 for a third training dataset 426 from the first generative AI model 402. The ML algorithm 314 of the training device 202 trains the second generative AI model 404 using the third set of training datapoints 424 from the third training dataset 426 using a loss function, such as loss function 430 and/or loss function 432.

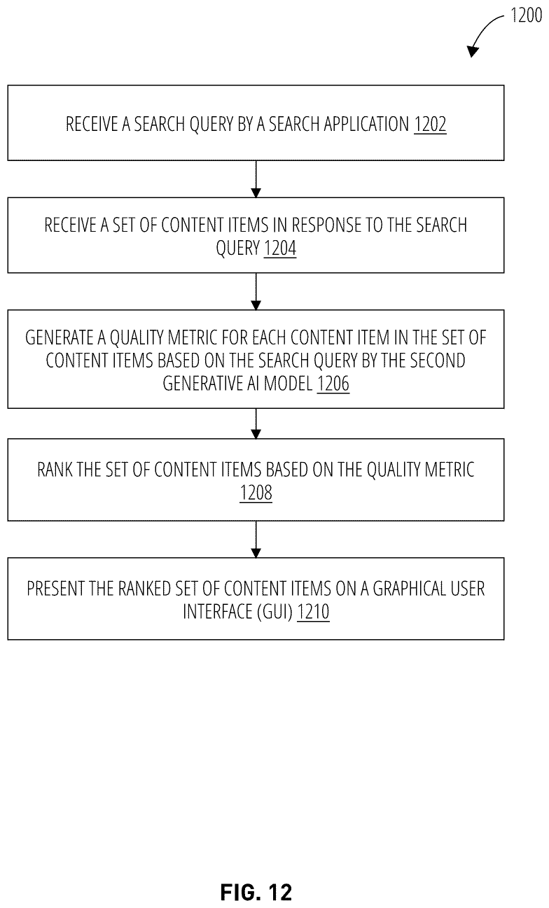

FIG. 12 illustrates an embodiment of a logic flow 1200. The logic flow 1200 may be representative of some or all of the operations executed by one or more embodiments described herein. For example, the logic flow 1200 may include some or all of the operations performed by devices or entities within the connection network platform 112 of the connection network system 100, such as the server device 102 and/or the client device 104. More particularly, the logic flow 1100 illustrates an example where the server device 102 performs a set of inferencing operations of a ML model such as a generative AI model to support one or more network services 146 provided by the connection network platform 112 of the connection network system 100. For example, the logic flow 1200 may be performed by the server device 102 and/or the client device 104 using a logic diagram 300, logic diagram 400, transformer model 500, logic diagram 600, logic diagram 700, logic diagram 800, or logic diagram 900.

As depicted in logic flow 1200, a block 1202 receives a search query by a search application. A block 1204 receives a set of content items in response to the search query. A block 1206 generates a quality metric for each content item in the set of content items based on the search query by the second generative AI model. A block 1208 ranks the set of content items based on the quality metric. A block 1210 presents the ranked set of content items on a graphical user interface (GUI).

By way of example, the search application 120 receives a search query 138 from a client device 104. The search application 120 searches for a set of content items 134 in response to the search query 138. The search application 120 instructs the second generative AI model 404, deployed as an inferencing model 436, to generate a quality metric 628 for each content item in the set of content items 134 based on the search query 138. A ranking algorithm 802 for the search application 120 and/or the ranking model 122 ranks the set of content items 134 based on the quality metric 628. The search application 120 causes a set of ranked content items 142 to be presented on a GUI 136 of the client device 104.

In one embodiment, for example, the search application 120 searches for a set of candidate content items 706 in response to the search query 138 using layered architecture 902. The layered architecture 902 may comprise a first ML model, such as an ML model 0 904, ML model 1 906, or ML model 2 908 of L0 912, L1 914, and L2 916, respectively. The first ML model searches for the candidate content items 706 in response to the search query 138 based on a first set of search criteria 704 (or ranking criteria). A second MLP, such as the inferencing model 436 of L3 918, selects a subset of candidate content items 706 from the set of candidate content items 706 based on a second set of search criteria 704, such as metrics 708 like a quality metric 628, an engagement metric 710, or a combination of both. The search application 120 sends the subset of candidate content items 706 as the set of content items 134 to the second generative AI model 404 for generating the ranked content items 142.

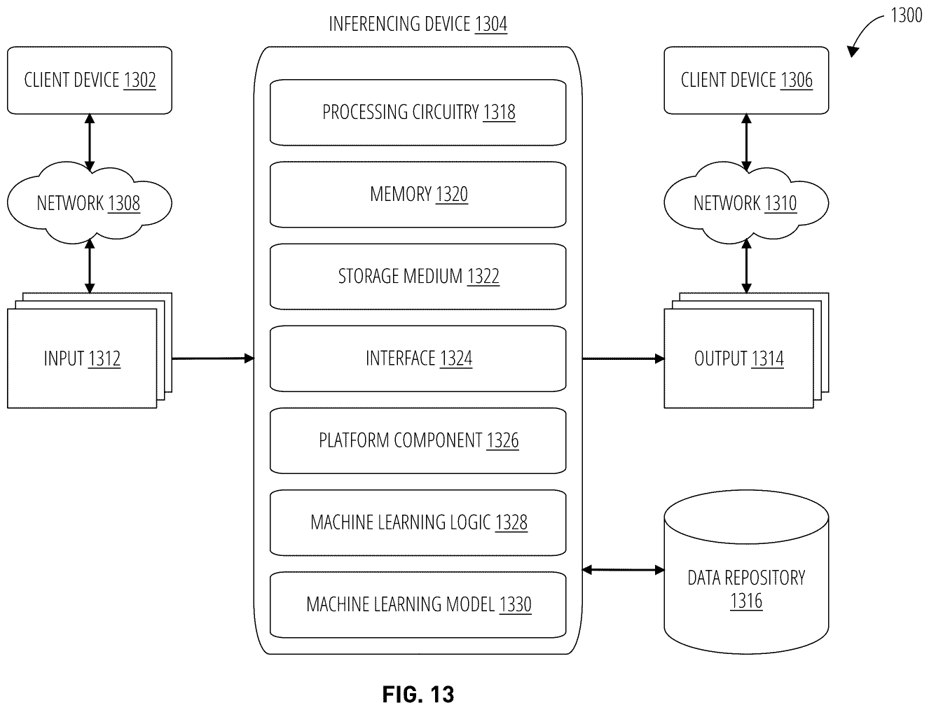

FIG. 13 illustrates an embodiment of a system 1300. The system 1300 is suitable for implementing one or more embodiments as described herein. In one embodiment, for example, the system 1300 is an AI/ML system suitable for implementing models described with reference to any of the preceding description.

The system 1300 comprises a set of M devices, where M is any positive integer. FIG. 13 depicts three devices (M=3), including a client device 1302, an inferencing device 1304, and a client device 1306. The inferencing device 1304 communicates information with the client device 1302 and the client device 1306 over a network 1308 and a network 1310, respectively. The information may include input 1312 from the client device 1302 and output 1314 to the client device 1306, or vice-versa. In one alternative, the input 1312 and the output 1314 are communicated between the same client device 1302 or client device 1306. In another alternative, the input 1312 and the output 1314 are stored in a data repository 1316. In yet another alternative, the input 1312 and the output 1314 are communicated via a platform component 1326 of the inferencing device 1304, such as an input/output (I/O) device (e.g., a touchscreen, a microphone, a speaker, etc.).

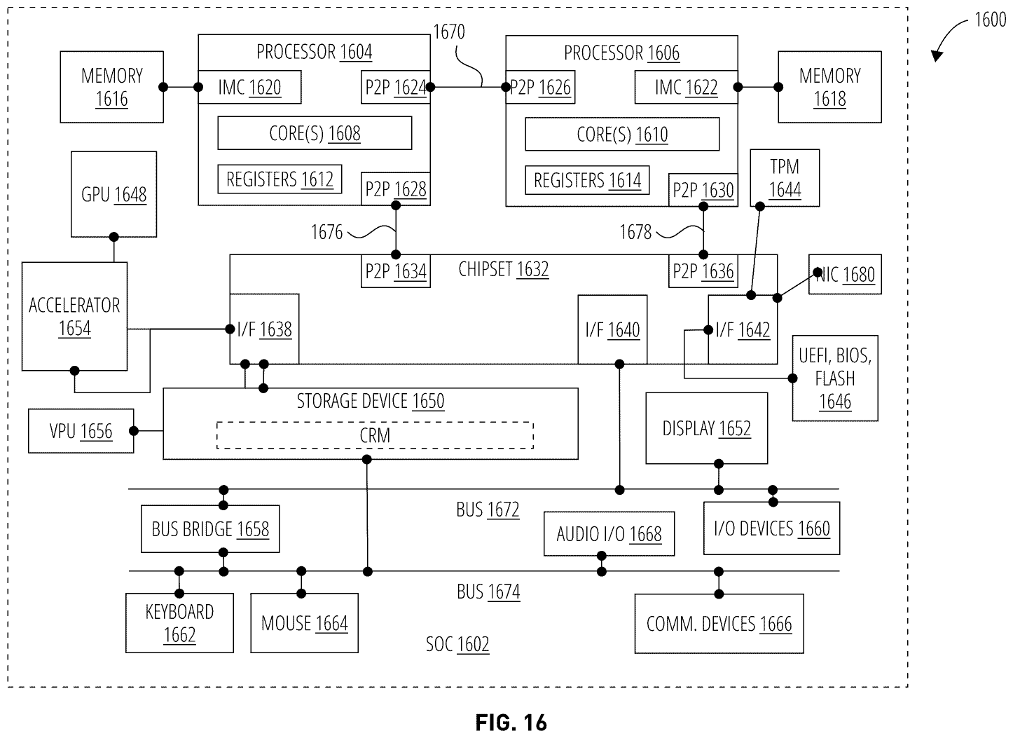

As depicted in FIG. 13, the inferencing device 1304 includes processing circuitry 1318, a memory 1320, a storage medium 1322, an interface 1324, a platform component 1326, ML logic 1328, and an ML model 1330. In some implementations, the inferencing device 1304 includes other components or devices as well. Examples for software elements and hardware elements of the inferencing device 1304 are described in more detail with reference to a computing architecture 1600 as depicted in FIG. 16. Embodiments are not limited to these examples.

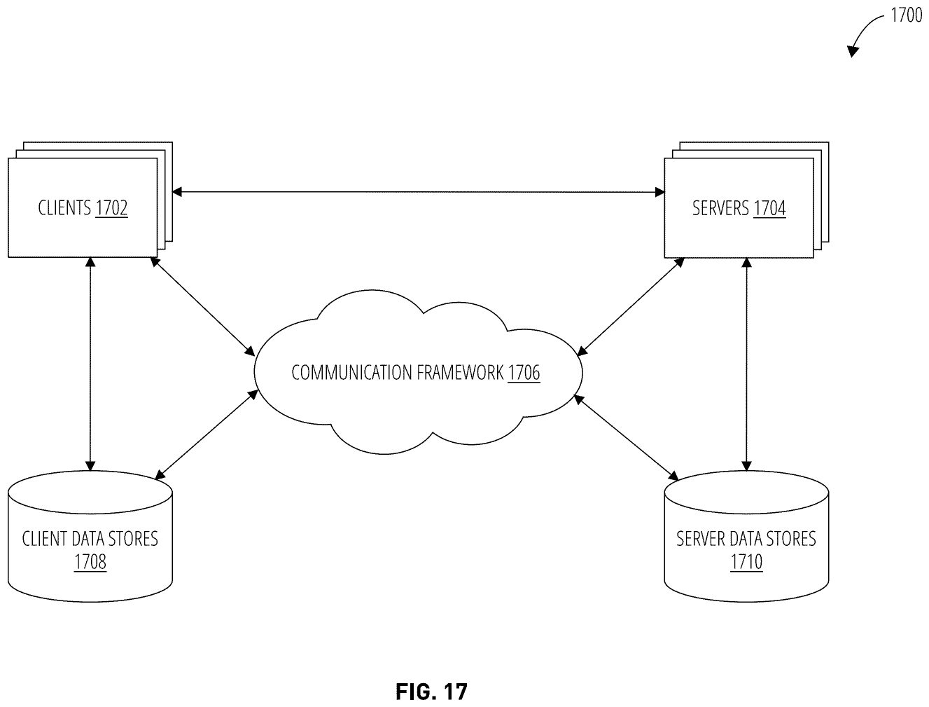

The inferencing device 1304 is generally arranged to receive an input 1312, process the input 1312 via one or more AI/ML techniques, and send an output 1314. The inferencing device 1304 receives the input 1312 from the client device 1302 via the network 1308, the client device 1306 via the network 1310, the platform component 1326 (e.g., a touchscreen as a text command or microphone as a voice command), the memory 1320, the storage medium 1322 or the data repository 1316. The inferencing device 1304 sends the output 1314 to the client device 1302 via the network 1308, the client device 1306 via the network 1310, the platform component 1326 (e.g., a touchscreen to present text, graphic or video information or speaker to reproduce audio information), the memory 1320, the storage medium 1322 or the data repository 1316. Examples for the software elements and hardware elements of the network 1308 and the network 1310 are described in more detail with reference to a communications architecture 1700 as depicted in FIG. 17. Embodiments are not limited to these examples.

The inferencing device 1304 includes ML logic 1328 and an ML model 1330 to implement various AI/ML techniques for various AI/ML tasks. The ML logic 1328 receives the input 1312, and processes the input 1312 using the ML model 1330. The ML model 1330 performs inferencing operations to generate an inference for a specific task from the input 1312. In some cases, the inference is part of the output 1314. The output 1314 is used by the client device 1302, the inferencing device 1304, or the client device 1306 to perform subsequent actions in response to the output 1314.

In various embodiments, the ML model 1330 is a trained ML model 1330 using a set of training operations. An example of training operations to train the ML model 1330 is described with reference to FIG. 2.

FIG. 14 illustrates an embodiment of an artificial neural network 1400. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1400 comprises multiple node layers, containing an input layer 1426, one or more hidden layers 1428, and an output layer 1430. Each layer comprises one or more nodes, such as nodes 1402 to 1424. As depicted in FIG. 14, for example, the input layer 1426 has nodes 1402, 1404. The artificial neural network 1400 has two hidden layers 1428, with a first hidden layer having nodes 1406, 1408, 1410 and 1412, and a second hidden layer having nodes 1414, 1416, 1418 and 1420. The artificial neural network 1400 has an output layer 1430 with nodes 1422, 1424. Each node 1402 to 1424 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1400 relies on training dataset 316 to learn and improve accuracy over time. However, once the artificial neural network 1400 is fine-tuned for accuracy, and tested on testing dataset 320, the artificial neural network 1400 is ready to classify and cluster new data 330 at a high velocity. Tasks in speech recognition or image recognition can take minutes versus hours when compared to the manual identification by human experts.

Each individual node 1402 to 424 is a linear regression model, composed of input data, weights, a bias (or threshold), and an output. The linear regression model may have a formula similar to Equation (10), as follows:

$$\sum wixi + bias = w 1 x 1 + w 2 x 2 + w 3 x 3 + bias \qquad EQUATION ( 10 )$$

$$output = f ( x ) = 1 if \sum w 1 x 1 + b >= 0 ; 0 if \sum w 1 x 1 + b < 0$$

Once an input layer 1426 is determined, a set of weights 1432 are assigned. The weights 1432 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1400 as a feedforward network.

In one embodiment, the artificial neural network 1400 leverages sigmoid neurons, which are distinguished by having values between 0 and 1. Since the artificial neural network 1400 behaves similarly to a decision tree, cascading data from one node to another, having x values between 0 and 1 will reduce the impact of any given change of a single variable on the output of any given node, and subsequently, the output of the artificial neural network 1400.

The artificial neural network 1400 has many practical use cases, like image recognition, speech recognition, text recognition or classification. The artificial neural network 1400 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = MSE = \frac{1}{2 m} {\sum }_{i = 1}^{m} {( \hat{{y}_{i}} - {y}_{i} )}^{2} \to MIN \qquad EQUATION ( 11 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1434 of the model adjust to gradually converge at the minimum.

In one embodiment, the artificial neural network 1400 is feedforward, meaning it flows in one direction only, from input to output. In one embodiment, the artificial neural network 1400 uses backpropagation. Backpropagation is when the artificial neural network 1400 moves in the opposite direction from output to input. Backpropagation allows calculation and attribution of errors associated with each neuron 1402 to 1424, thereby allowing adjustment to fit the parameters 1434 of the ML model 1330 appropriately.

The artificial neural network 1400 is implemented as different neural networks depending on a given task. Neural networks are classified into different types, which are used for different purposes. In one embodiment, the artificial neural network 1400 is implemented as a feedforward neural network, or multi-layer perceptrons (MLPs), comprised of an input layer 1426, hidden layers 1428, and an output layer 1430. While these neural networks are also commonly referred to as MLPs, they are actually comprised of sigmoid neurons, not perceptrons, as most real-world problems are nonlinear. Trained data 304 usually is fed into these models to train them, and they are the foundation for computer vision, natural language processing, and other neural networks. In one embodiment, the artificial neural network 1400 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1400 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1400 is implemented as any type of neural network suitable for a given operational task of system 1300, and the MLP, CNN, and RNN are merely a few examples. Embodiments are not limited in this context.

The artificial neural network 1400 includes a set of associated parameters 1434. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1400 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1436. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

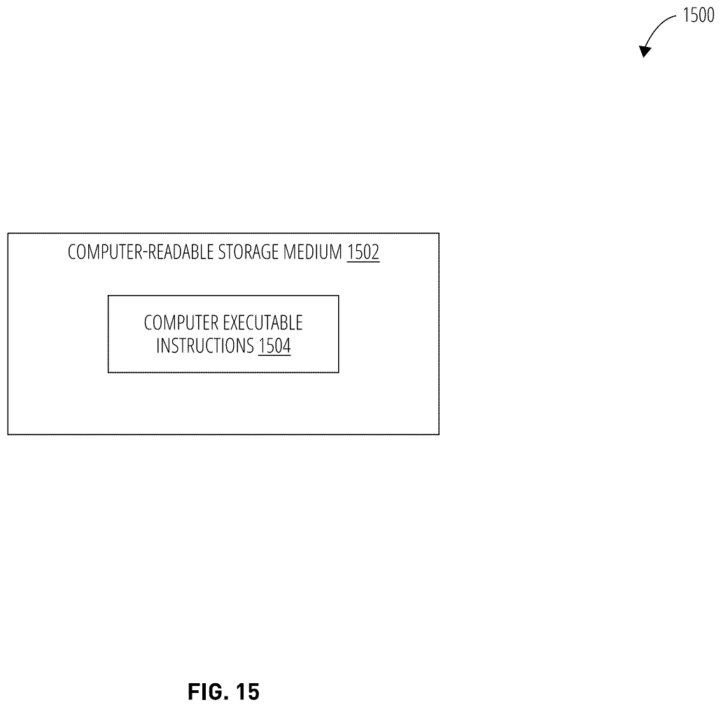

FIG. 15 illustrates an apparatus 1500. Apparatus 1500 comprises any non-transitory computer-readable storage medium 1502 or machine-readable storage medium, such as an optical, magnetic or semiconductor storage medium. In various embodiments, apparatus 1500 comprises an article of manufacture or a product. In some embodiments, the computer-readable storage medium 1502 stores computer executable instructions with which one or more processing devices or processing circuitry can execute. For example, computer executable instructions 1504 includes instructions to implement operations described with respect to any logic flows described herein. Examples of computer-readable storage medium 1502 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1504 include any suitable type of code, such as source code, compiled code, interpreted code, executable code, static code, dynamic code, object-oriented code, visual code, and the like.

FIG. 16 illustrates an embodiment of a computing architecture 1600. Computing architecture 1600 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1600 has a single processor with one core or more than one processor. Note that the term “processor” refers to a processor with a single core or a processor package with multiple processor cores. In at least one embodiment, the computing architecture 1600 is representative of the components of the system 1300. More generally, the computing architecture 1600 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1600. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 16, computing architecture 1600 comprises a system-on-chip (SoC) 1602 for mounting platform components. System-on-chip (SoC) 1602 is a point-to-point (P2P) interconnect platform that includes a first processor 1604 and a second processor 1606 coupled via a point-to-point interconnect 1670 such as an Ultra Path Interconnect (UPI). In other embodiments, the computing architecture 1600 is another bus architecture, such as a multi-drop bus. Furthermore, each of processor 1604 and processor 1606 are processor packages with multiple processor cores including core(s) 1608 and core(s) 1610, respectively. While the computing architecture 1600 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1604 and chipset 1632. Some platforms include additional components and some platforms include sockets to mount the processors and/or the chipset. Furthermore, some platforms do not have sockets (e.g. SoC, or the like). Although depicted as a SoC 1602, one or more of the components of the SoC 1602 are included in a single die package, a multi-chip module (MCM), a multi-die package, a chiplet, a bridge, and/or an interposer. Therefore, embodiments are not limited to a SoC.

The processor 1604 and processor 1606 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1604 and/or processor 1606. Additionally, the processor 1604 need not be identical to processor 1606.

Processor 1604 includes an integrated memory controller (IMC) 1620 and point-to-point (P2P) interface 1624 and P2P interface 1628. Similarly, the processor 1606 includes an IMC 1622 as well as P2P interface 1626 and P2P interface 1630. IMC 1620 and IMC 1622 couple the processor 1604 and processor 1606, respectively, to respective memories (e.g., memory 1616 and memory 1618). Memory 1616 and memory 1618 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1616 and the memory 1618 locally attach to the respective processors (i.e., processor 1604 and processor 1606). In other embodiments, the main memory couple with the processors via a bus and shared memory hub. Processor 1604 includes registers 1612 and processor 1606 includes registers 1614.

Computing architecture 1600 includes chipset 1632 coupled to processor 1604 and processor 1606. Furthermore, chipset 1632 are coupled to storage device 1650, for example, via an interface (I/F) 1638. The I/F 1638 may be, for example, a Peripheral Component Interconnect-enhanced (PCIe) interface, a Compute Express Link® (CXL) interface, or a Universal Chiplet Interconnect Express (UCIe) interface. Storage device 1650 stores instructions executable by circuitry of computing architecture 1600 (e.g., processor 1604, processor 1606, GPU 1648, accelerator 1654, vision processing unit 1656, or the like). For example, storage device 1650 can store instructions for the client device 1302, the client device 1306, the inferencing device 1304, the training device 202, or the like.

Processor 1604 couples to the chipset 1632 via P2P interface 1628 and P2P 1634 while processor 1606 couples to the chipset 1632 via P2P interface 1630 and P2P 1636. Direct media interface (DMI) 1676 and DMI 1678 couple the P2P interface 1628 and the P2P 1634 and the P2P interface 1630 and P2P 1636, respectively. DMI 1676 and DMI 1678 is a high-speed interconnect that facilitates, e.g., eight Giga Transfers per second (GT/s) such as DMI 3.0. In other embodiments, the processor 1604 and processor 1606 interconnect via a bus.

The chipset 1632 comprises a controller hub such as a platform controller hub (PCH). The chipset 1632 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1632 comprises more than one controller hub such as a chipset with a memory controller hub, a graphics controller hub, and an input/output (I/O) controller hub.

In the depicted example, chipset 1632 couples with a trusted platform module (TPM) 1644 and UEFI, BIOS, FLASH circuitry 1646 via I/F 1642. The TPM 1644 is a dedicated microcontroller designed to secure hardware by integrating cryptographic keys into devices. The UEFI, BIOS, FLASH circuitry 1646 may provide pre-boot code. The I/F 1642 may also be coupled to a network interface circuit (NIC) 1680 for connections off-chip.

Furthermore, chipset 1632 includes the I/F 1638 to couple chipset 1632 with a high-performance graphics engine, such as, graphics processing circuitry or a graphics processing unit (GPU) 1648. In other embodiments, the computing architecture 1600 includes a flexible display interface (FDI) (not shown) between the processor 1604 and/or the processor 1606 and the chipset 1632. The FDI interconnects a graphics processor core in one or more of processor 1604 and/or processor 1606 with the chipset 1632.

The computing architecture 1600 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1654 and/or vision processing unit 1656 are coupled to chipset 1632 via I/F 1638. The accelerator 1654 is representative of any type of accelerator device (e.g., a data streaming accelerator, cryptographic accelerator, cryptographic co-processor, an offload engine, etc.). One example of an accelerator 1654 is the Intel® Data Streaming Accelerator (DSA). The accelerator 1654 is a device including circuitry to accelerate copy operations, data encryption, hash value computation, data comparison operations (including comparison of data in memory 1616 and/or memory 1618), and/or data compression. Examples for the accelerator 1654 include a USB device, PCI device, PCIe device, CXL device, UCIe device, and/or an SPI device. The accelerator 1654 also includes circuitry arranged to execute machine learning (ML) related operations (e.g., training, inference, etc.) for ML models. Generally, the accelerator 1654 is specially designed to perform computationally intensive operations, such as hash value computations, comparison operations, cryptographic operations, and/or compression operations, in a manner that is more efficient than when performed by the processor 1604 or processor 1606. Because the load of the computing architecture 1600 includes hash value computations, comparison operations, cryptographic operations, and/or compression operations, the accelerator 1654 greatly increases performance of the computing architecture 1600 for these operations.

The accelerator 1654 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1654. For example, the accelerator 1654 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1654 via a non-posted write (e.g., a deferred memory write (DMWr)). One example of an instruction that atomically submits a work descriptor to the shared work queue of the accelerator 1654 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1654. The dedicated work queue may accept job submissions via commands such as the movdir64b instruction.

Various I/O devices 1660 and display 1652 couple to the bus 1672, along with a bus bridge 1658 which couples the bus 1672 to a second bus 1674 and an I/F 1640 that connects the bus 1672 with the chipset 1632. In one embodiment, the second bus 1674 is a low pin count (LPC) bus. Various input/output (I/O) devices couple to the second bus 1674 including, for example, a keyboard 1662, a mouse 1664 and communication devices 1666.

Furthermore, an audio I/O 1668 couples to second bus 1674. Many of the I/O devices 1660 and communication devices 1666 reside on the system-on-chip (SoC) 1602 while the keyboard 1662 and the mouse 1664 are add-on peripherals. In other embodiments, some or all the I/O devices 1660 and communication devices 1666 are add-on peripherals and do not reside on the system-on-chip (SoC) 1602.

FIG. 17 illustrates a block diagram of an exemplary communications architecture 1700 suitable for implementing various embodiments as previously described. The communications architecture 1700 includes various common communications elements, such as a transmitter, receiver, transceiver, radio, network interface, baseband processor, antenna, amplifiers, filters, power supplies, and so forth. The embodiments, however, are not limited to implementation by the communications architecture 1700.

As shown in FIG. 17, the communications architecture 1700 includes one or more clients 1702 and servers 1704. The clients 1702 and the servers 1704 are operatively connected to one or more respective client data stores 1708 and server data stores 1710 that can be employed to store information local to the respective clients 1702 and servers 1704, such as cookies and/or associated contextual information.

The clients 1702 and the servers 1704 communicate information between each other using a communication framework 1706. The communication framework 1706 implements any well-known communications techniques and protocols. The communication framework 1706 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1706 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/1300/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1702 and the servers 1704. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice.

According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

What is claimed is:

1. A method, comprising:
generating a first training prompt based on a first set of guidelines for a network service of a connection network system, the first set of guidelines defining an objective for the network service;
sending the first training prompt and a first set of training datapoints from a first training dataset to a first generative artificial intelligence (AI) model, a training datapoint from the first set of training datapoints comprising a content item;
receiving a second set of training datapoints for a second training dataset generated by the first generative AI model, wherein a training datapoint of the second training dataset comprises a first label for the content item generated by the first generative AI model based on the objective; and
training a second generative AI model using the second set of training datapoints from the second training dataset using a loss function to cause the second generative AI model to generate a second label that corresponds to the first label for the content item based on the objective.

2. The method of claim 1, wherein a guideline from the first set of guidelines defines a quality objective for the network service, the guideline comprising a series of natural language processing (NLP) instructions in a chain of thought (CoT) format to determine a quality level of a content item.

3. The method of claim 1, comprising:
retrieving a guideline from the first set of guidelines, the guideline comprising a series of natural language processing (NLP) instructions in a chain of thought (CoT) format;
determining a quality level of the content item in the training datapoint from the first training dataset using the series of NLP instructions from the guideline by the first generative AI model;
generating the first label representing the quality level of the content item in the training datapoint from the first training dataset by the first generative AI model; and
adding the first label for the content item to the training datapoint for the second training dataset.

4. The method of claim 1, comprising:
pretraining the second generative AI model using the first set of training datapoints from the first training dataset and a first loss function; and
training the pretrained second generative AI model using the second set of training datapoints from the second training dataset and a second loss function.

5. The method of claim 1, wherein the first set of guidelines define a quality objective for a search service of the connection network system, further comprising:
retrieving the training datapoint from the second training dataset, the training datapoint comprising a search query, a content item, and the first label for the content item;
generating an input vector for the second generative AI model, the input vector comprising a classification token (CLS) and a concatenation of the search query and the content item separated by a separator token (SEP);
generating the second label for the content item based on the input vector by the second generative AI model;
determining a difference between the first label and the second label for the content item;
modifying one or more parameters for the second generative AI model based on the difference using a cross-entropy loss function.

6. The method of claim 1, wherein the first generative AI model is a large language model (LLM) having a first set of parameters and a first set of neural network layers, and the second generative AI model is a LLM having a second set of parameters and a second set of neural network layers, where the first set of parameters is greater than the second set of parameters or the first set of neural network layers are greater than the second set of neural network layers.

7. The method of claim 1, comprising:
generating a second training prompt for the first generative AI model, the second training prompt based on a second set of guidelines for the network service of the connection network system, the second set of guidelines defining an objective for the network service;
sending the second training prompt and a first set of training datapoints from a first training dataset to the first generative AI model;
receiving a third set of training datapoints for a third training dataset from the first generative AI model; and
training the second generative AI model using the third set of training datapoints from the third training dataset using the loss function.

8. The method of claim 1, comprising:
receiving a search query by a search application;
receiving a set of content items in response to the search query;
generating a quality metric for each content item in the set of content items based on the search query by the second generative AI model;
ranking the set of content items based on the quality metric; and
presenting the ranked set of content items on a graphical user interface (GUI).

9. The method of claim 8, comprising:
searching for a set of candidate content items in response to the search query using a first multi-objective multilayer perceptron (MLP) based on a first set of search criteria;
selecting a subset of candidate content items from the set of candidate content items by a second MLP based on a second set of search criteria; and
sending the subset of candidate content items as the set of content items to the second generative AI model.

10. A computing apparatus, comprising:
circuitry; and
a memory storing instructions that, when executed by the circuitry, causes the circuitry to:
generate a first training prompt based on a first set of guidelines for a network service of a connection network system, the first set of guidelines defining an objective for the network service;
send the first training prompt and a first set of training datapoints from a first training dataset to a first generative artificial intelligence (AI) model, a training datapoint from the first set of training datapoints comprising a content item;
receive a second set of training datapoints for a second training dataset from the first generative AI model, wherein a training datapoint of the second training dataset comprises a first label for the content item generated by the first generative AI model based on the objective; and
train a second generative AI model using the second set of training datapoints from the second training dataset using a loss function in order for the second generative AI model to generate a second label that corresponds to the first label for the content item based on the objective.

11. The computing apparatus of claim 10, wherein a guideline from the first set of guidelines defines a quality objective for the network service, the guideline comprising a series of natural language process (NLP) instructions in a chain of thought (CoT) format to determine a quality level of a content item.

12. The computing apparatus of claim 10, comprising the circuitry to:
retrieve a guideline from the first set of guidelines, the guideline comprising a series of natural language processing (NLP) instructions in a chain of thought (CoT) format;
determine a quality level of the content item in the training datapoint from the first training dataset using the series of NLP instructions from the guideline by the first generative AI model;
generate the first label representing the quality level of the content item in the training datapoint from the first training dataset by the first generative AI model; and
add the first label for the content item to the training datapoint for the second training dataset.

13. The computing apparatus of claim 10, comprising:
generate a second training prompt for the first generative AI model, the second training prompt based on a second set of guidelines for the network service of the connection network system, the second set of guidelines defining an objective for the network service;
send the second training prompt and a first set of training datapoints from a first training dataset to the first generative AI model;
receive a third set of training datapoints for a third training dataset from the generative AI model; and
train the second generative AI model using the third set of training datapoints from the third training dataset using the loss function.

14. The computing apparatus of claim 10, comprising:
receive a search query by a search application;
receive a set of content items in response to the search query;
generate a quality metric for each content item in the set of content items based on the search query by the second generative AI model;
rank the set of content items based on the quality metric; and
present the ranked set of content items on a graphical user interface (GUI).

15. The computing apparatus of claim 14, comprising:
search for a set of candidate content items in response to the search query using a first multi-objective multilayer perceptron (MLP) based on a first set of search criteria;
select a subset of candidate content items from the set of candidate content items by a second MLP based on a second set of search criteria; and
send the subset of candidate content items as the set of content items to the second generative AI model.

16. A non-transitory computer-readable storage medium, the computer-readable storage medium including instructions that when executed by circuitry, cause the circuitry to:
generate a first training prompt based on a first set of guidelines for a network service of a connection network system, the first set of guidelines defining an objective for the network service;
send the first training prompt and a first set of training datapoints from a first training dataset to a first generative artificial intelligence (AI) model, a training datapoint from the first set of training datapoints comprising a content item;
receive a second set of training datapoints for a second training dataset from the first generative AI model, wherein a training datapoint of the second training dataset comprises a first label for the content item generated by the first generative AI model based on the objective; and
train a second generative AI model using the second set of training datapoints from the second training dataset using a loss function in order for the second generative AI model to generate a second label that corresponds to the first label for the content item based on the objective.

17. The computer-readable storage medium of claim 16, wherein a guideline from the first set of guidelines defines a quality objective for the network service, the guideline comprising a series of natural language process (NLP) instructions in a chain of thought (CoT) format to determine a quality level of a content item.

18. The computer-readable storage medium of claim 16, comprising:
retrieve a guideline from the first set of guidelines, the guideline comprising a series of natural language processing (NLP) instructions in a chain of thought (CoT) format;
determine a quality level of the content item in the training datapoint from the first training dataset using the series of NLP instructions from the guideline by the first generative AI model;
generate the first label representing the quality level of the content item in the training datapoint from the first training dataset by the first generative AI model; and
add the first label for the content item to the training datapoint for the second training dataset.

19. The computer-readable storage medium of claim 16, comprising:
generate a second training prompt for the first generative AI model, the second training prompt based on a second set of guidelines for the network service of the connection network system, the second set of guidelines defining an objective for the network service;
send the second training prompt and a first set of training datapoints from a first training dataset to the first generative AI model;
receive a third set of training datapoints for a third training dataset from the generative AI model; and
train the second generative AI model using the third set of training datapoints from the third training dataset using the loss function.

20. The computer-readable storage medium of claim 16, comprising:
receive a search query by a search application;
receive a set of content items in response to the search query;
generate a quality metric for each content item in the set of content items based on the search query by the second generative AI model;
rank the set of content items based on the quality metric; and
present the ranked set of content items on a graphical user interface (GUI).
